(19) United States
(12) Patent Application Publication
(10) Pub. No.: US 2025/0370670 A1
(43) Pub. Date: Dec. 4, 2025

(54) PRINTING APPARATUS

(71) Applicant: BROTHER KOGYO KABUSHIKI KAISHA, Nagoya (JP)

(72) Inventor: Miki NISHIMURA, Nagoya (JP)

(21) Appl. No.: 19/221,656

(22) Filed: May 29, 2025

(30) Foreign Application Priority Data
May 31, 2024 (JP) 2024-088575
Dec. 27, 2024 (JP) 2024-232189

(51) Int. Cl. G06F 3/12; B41J 3/46; B41J 29/393; G03G 15/00; G06F 8/65; G06Q 10/1093

(52) U.S. Cl. CPC G06F 3/123; G06F 3/1204; G06F 3/1288; G06F 8/65; G06Q 10/1097; B41J 3/46; B41J 29/393; G03G 15/5016; G03G 15/5079

(57) ABSTRACT

A printing apparatus includes a controller. The controller is configured to: access a firmware server, download firmware for update from the firmware server, and update firmware stored in a memory with the downloaded firmware for update; receive an input for designating a time slot via a user interface; determine an access time to the firmware server from a time slot, the time slot being a first time slot or a second time slot, the first time slot being from a start time of the designated time slot to a time before an end time of the designated time slot by a predetermined time, the second time slot being from the start time of the designated time slot to the end time of the designated time slot; and access the firmware server at the determined access time every time a date for accessing the firmware server arrives.

### REFERENCE TO RELATED APPLICATIONS

This application claims priority from Japanese Patent Application No. 2024-088575 filed on May 31, 2024 and Japanese Patent Application No. 2024-232189 filed on Dec. 27, 2024. The entire contents of the priority applications are incorporated herein by reference.

### BACKGROUND ART

The present application relates to a printing apparatus capable of downloading and updating firmware.

An example of an image forming apparatus updates its own firmware with firmware acquired from a server.

### DESCRIPTION

The inventor of the present application has conceived of improving usability for a user in updating firmware.

An object of the present application is to provide a printing apparatus capable of improving usability for a user in updating firmware.

In one aspect of the present application, a printing apparatus is configured to access a firmware server on an Internet via a network interface, download firmware for update from the firmware server, and update the firmware stored in a memory with the downloaded firmware for update. The printing apparatus is configured to receive an input for designating a time slot via a user interface. The printing apparatus is configured to determine an access time to the firmware server from a time slot. The time slot may be a first time slot or a second time slot. The first time slot is from a start time of the designated time slot to a time before an end time of the designated time slot by a predetermined time. The second time slot is from the start time of the designated time slot to the end time of the designated time slot.

According to the printing apparatus described in the embodiment, the firmware stored in the memory can be updated with the downloaded firmware for update. According to the printing apparatus, the input for designating the time slot can be received. According to the printing apparatus, the access time to the firmware server can be determined from the first time slot or from the second time slot. According to the printing apparatus, even if a plurality of printing apparatuses access the firmware server on overlapping dates and in overlapping time slots, the access times to the firmware server are distributed, thereby reducing the concentration of a load on the firmware server. In addition, there is a high possibility that the firmware can be attempted to be updated on a date and in a time slot convenient for the user, and that the update of the firmware can be finished within the time slot convenient for the user.

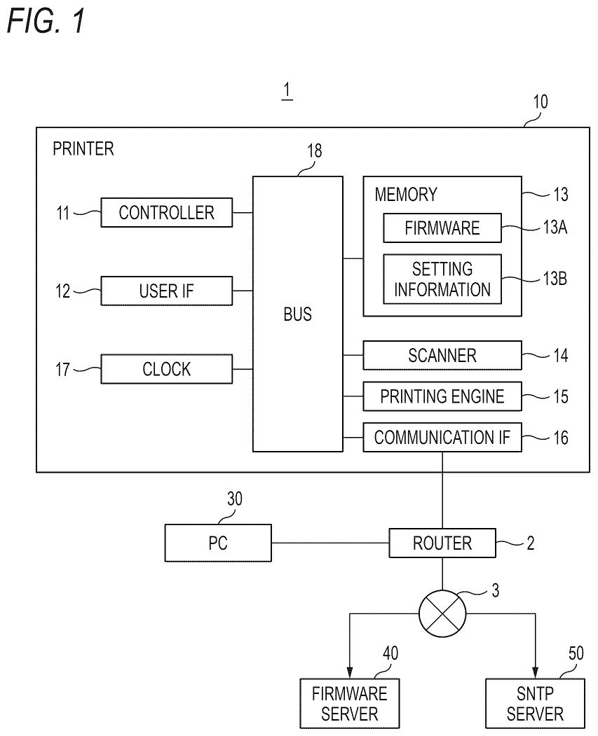

FIG. 1 is a block diagram of an image forming system.

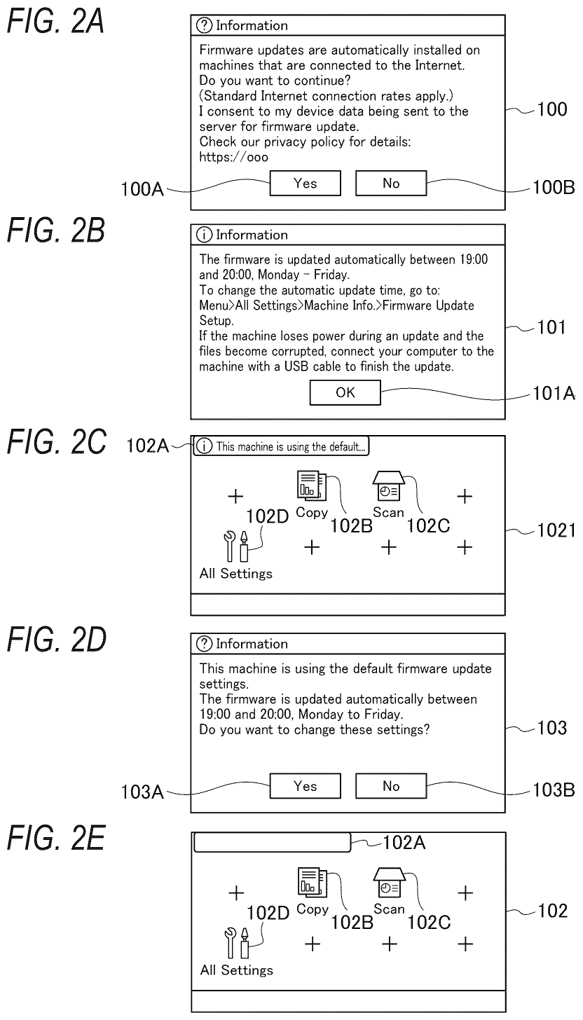

FIGS. 2A to 2E are diagrams illustrating an example of a transition of operation screens at the time of initial installation.

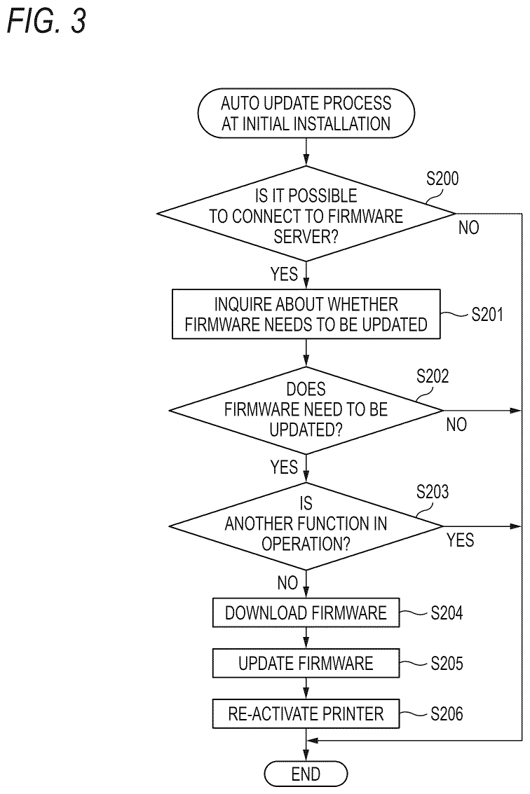

FIG. 3 is a flowchart illustrating a procedure of an Auto Update process at the time of the initial installation.

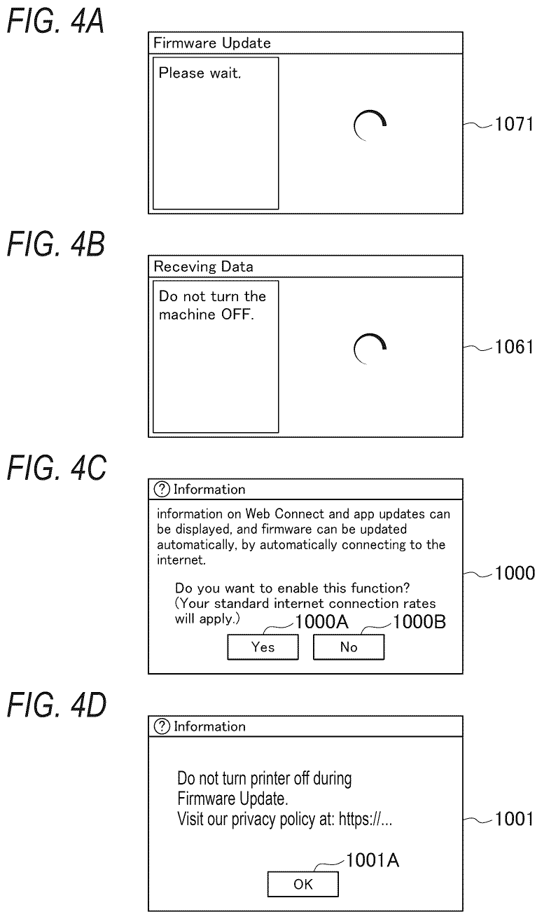

FIGS. 4A to 4D are diagrams illustrating an example of a transition of display screens in the Auto Update process at the time of initial installation, and another example of a transition of operation screens at the time of the initial installation.

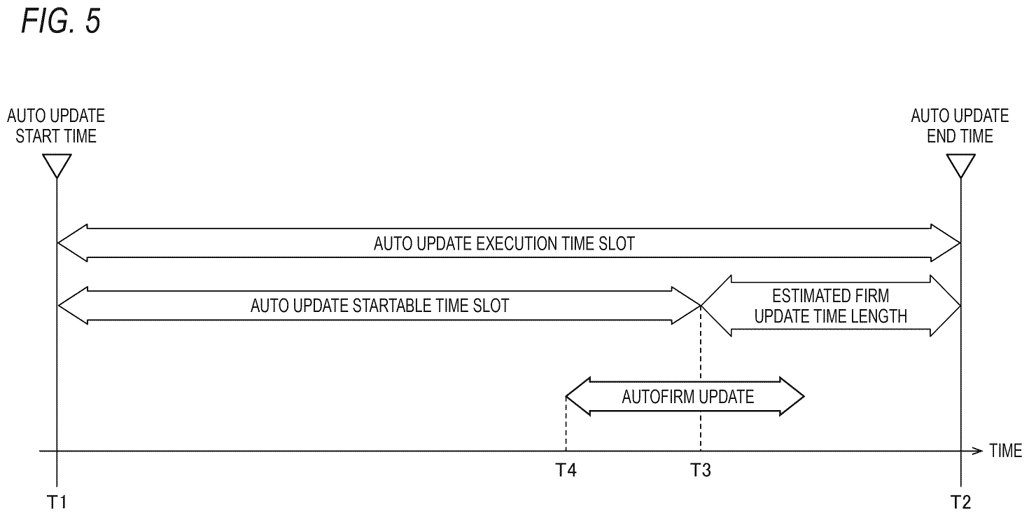

FIG. 5 is a diagram illustrating a process of determining an access time to the firmware server.

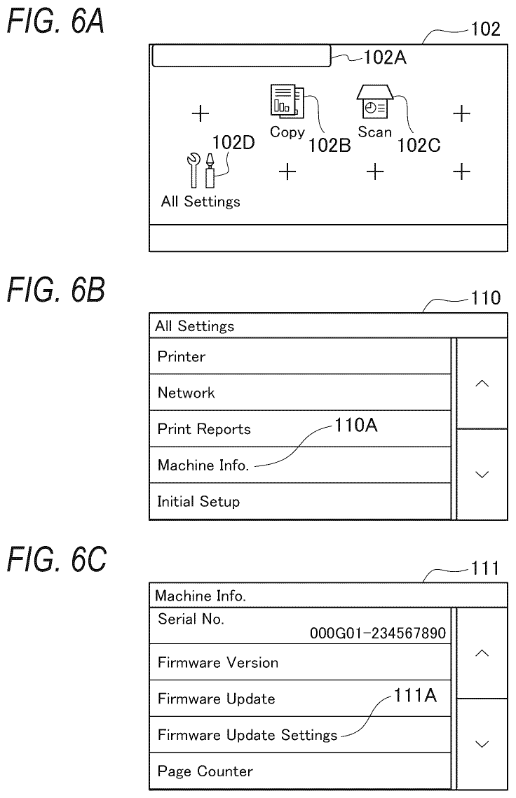

FIGS. 6A to 6C are diagrams illustrating an example of a transition of operation screens at the time of setting change.

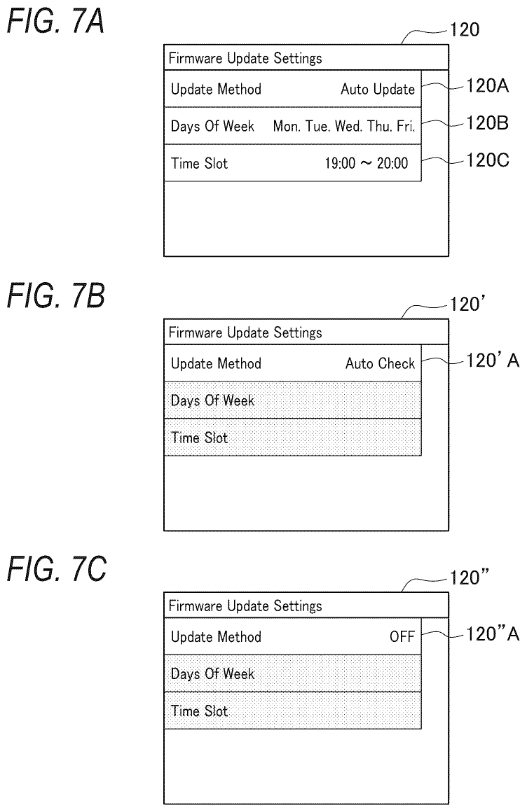

FIGS. 7A to 7C are diagrams illustrating examples of Firmware Update Settings screens when update methods are different.

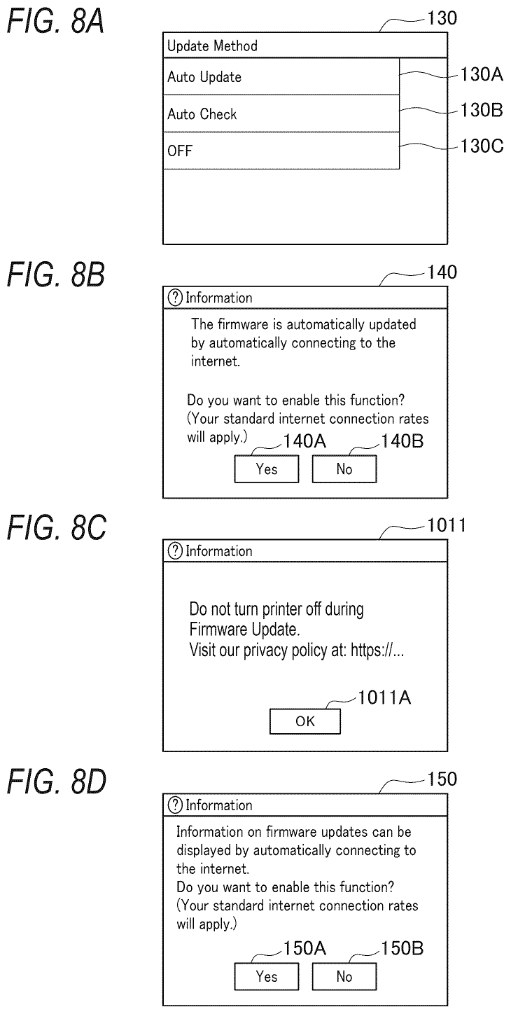

FIGS. 8A to 8D are diagrams illustrating an example of a transition of operation screens starting from an Update Method setting screen.

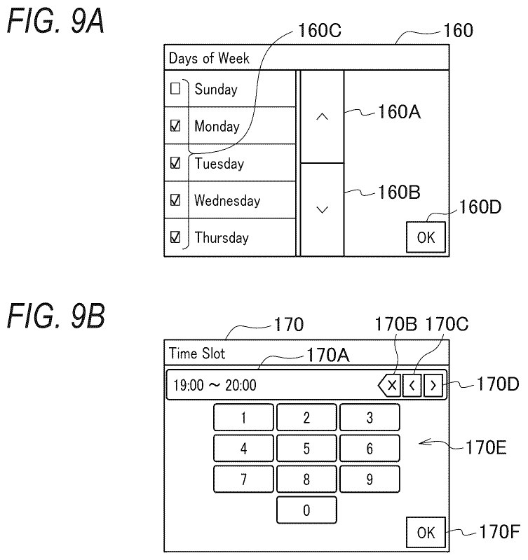

FIGS. 9A and 9B are diagrams illustrating examples of a Days Of Week setting screen and a Time Slot setting screen.

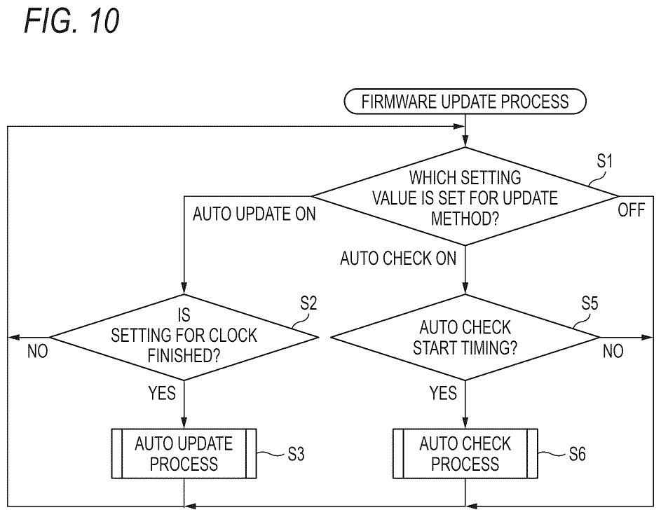

FIG. 10 is a flowchart illustrating a procedure of a Firmware Update process.

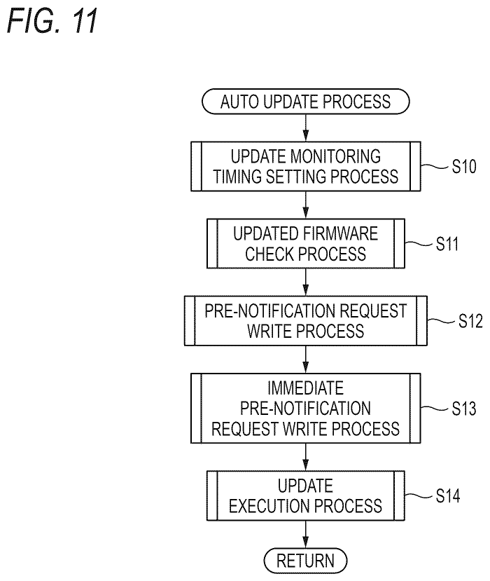

FIG. 11 is a flowchart illustrating a procedure of an Auto Update process.

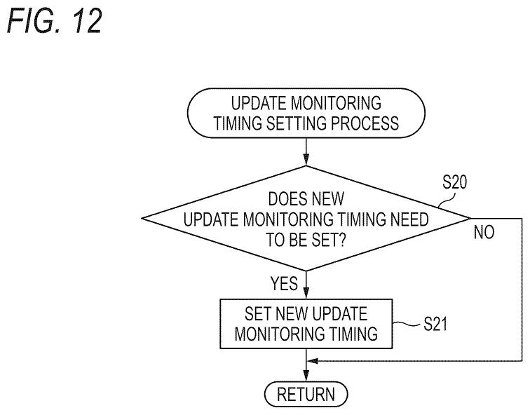

FIG. 12 is a flowchart illustrating a procedure of an update monitoring timing setting process.

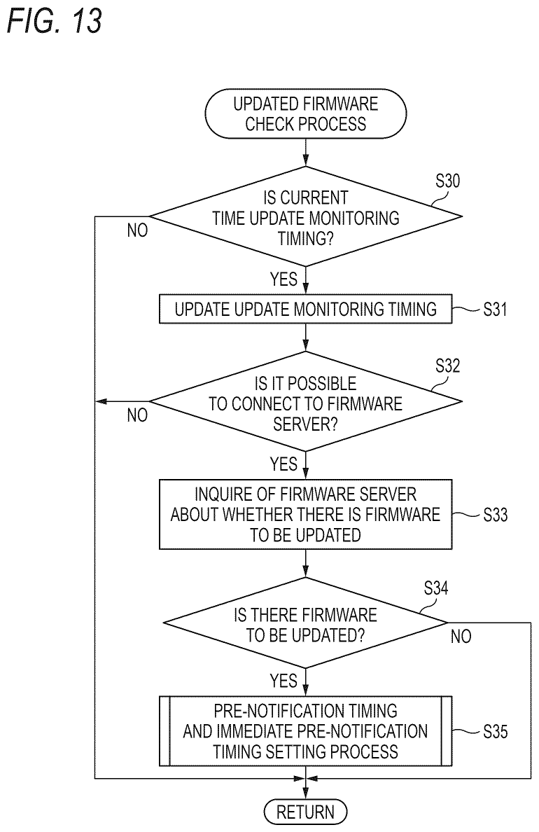

FIG. 13 is a flowchart illustrating a procedure of an updated firmware check process.

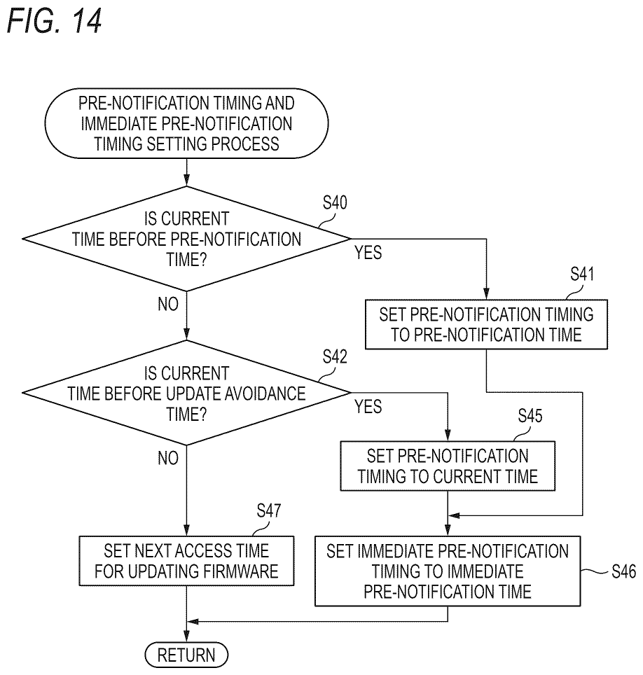

FIG. 14 is a flowchart illustrating a procedure of a pre-notification timing and immediate pre-notification timing setting process.

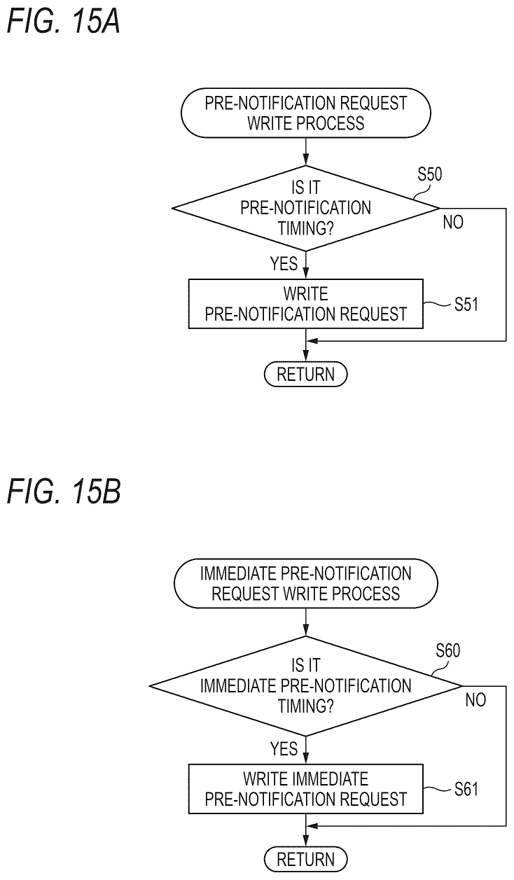

FIGS. 15A and 15B is a flowchart illustrating procedures of a pre-notification request write process and an immediate pre-notification request write process.

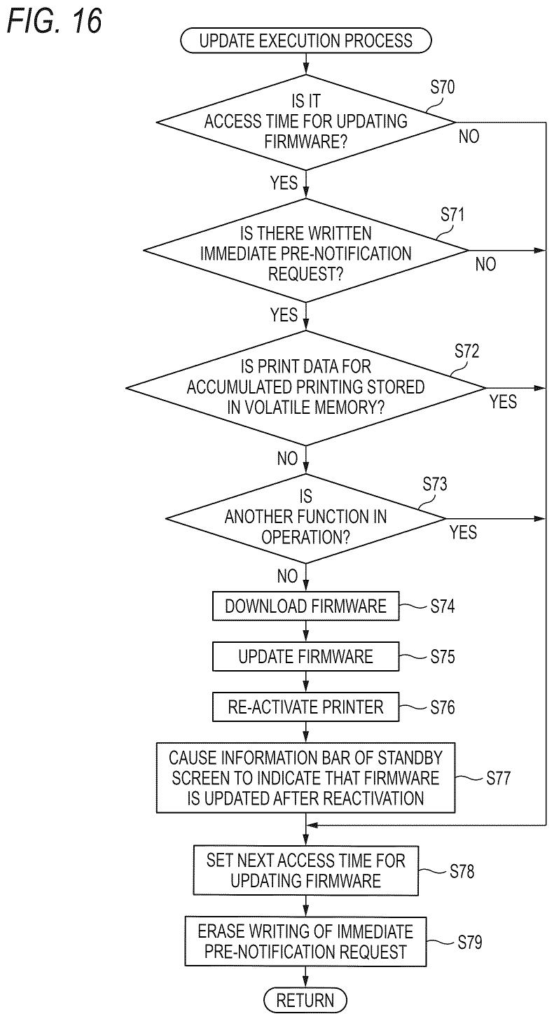

FIG. 16 is a flowchart illustrating a procedure of an update execution process.

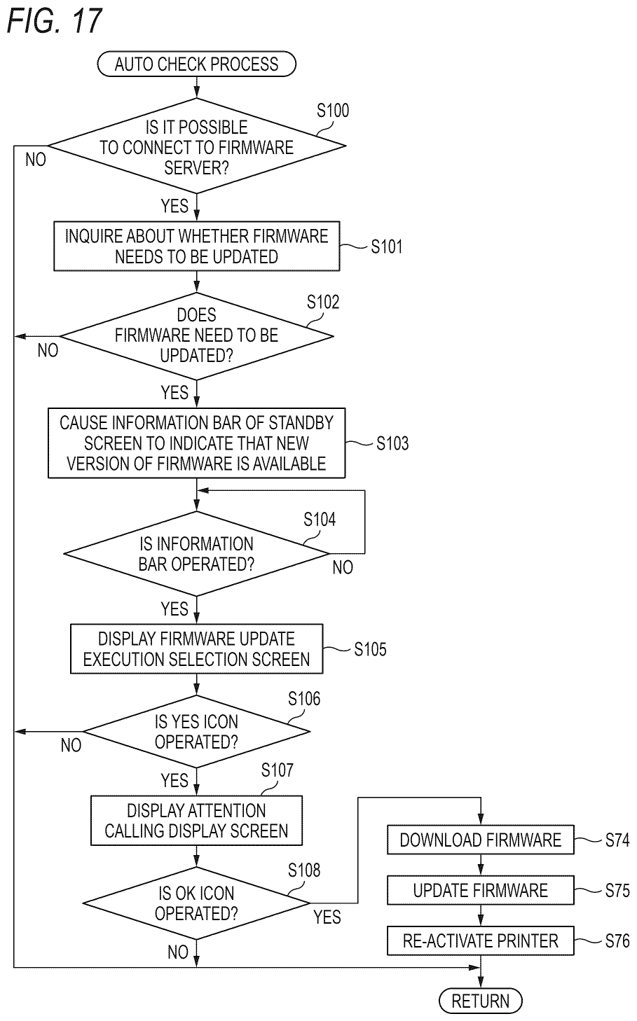

FIG. 17 is a flowchart illustrating a procedure of an Auto Check process.

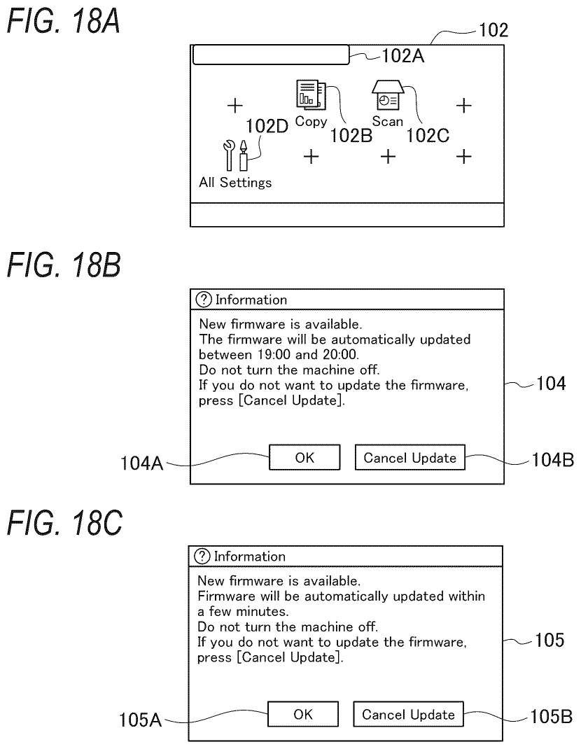

FIGS. 18A to 18C are diagrams illustrating an example of a transition of display screens in the Auto Update process.

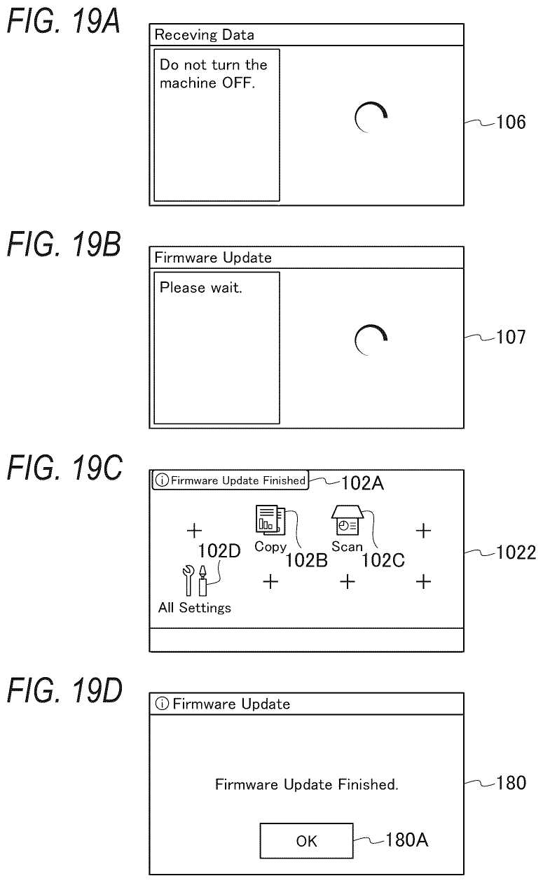

FIGS. 19A to 19D are diagrams illustrating another example of a transition of display screens in the Auto Update process.

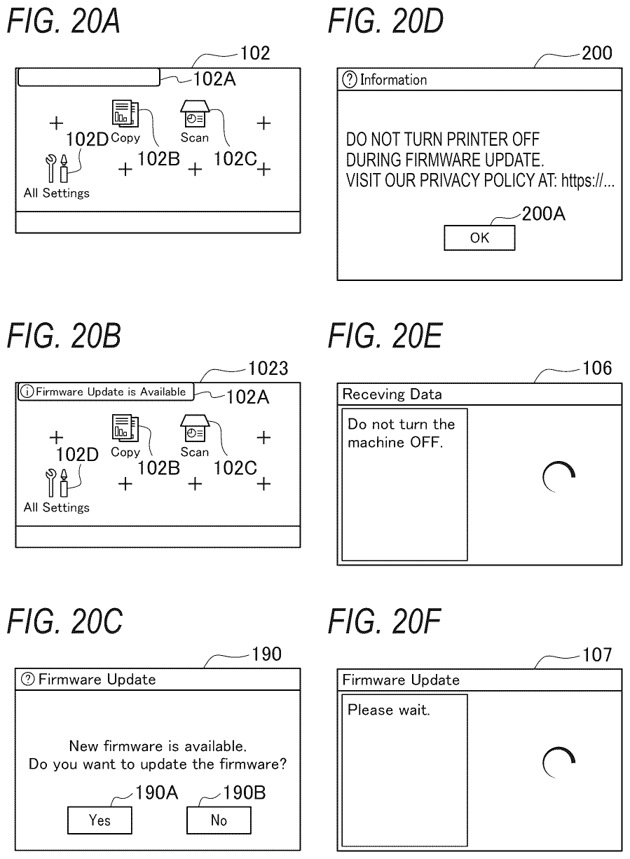

FIGS. 20A to 20F are diagrams illustrating an example of a transition of operation screens in the Auto Check process.

Hereinafter, an embodiment of the present application will be described in detail with reference to the drawings.

FIG. 1 is a block diagram of an image forming system 1 according to an embodiment. The image forming system 1 illustrated in FIG. 1 includes a printer (an example of a printing apparatus) 10, a PC (an example of an external computer) 30, a firmware server 40, and an SNTP server 50. SNTP is an abbreviation of Simple Network Time Protocol. The printer 10 and the PC 30 are connected to each other in a wired or wireless manner (for example, via a LAN) via a router 2 so as to be able to communicate with each other. LAN is an abbreviation of Local Area Network. The printer 10, the firmware server 40, and the SNTP server 50 are connected to each other via the router 2 and the Internet 3 so as to be able to communicate with each other. This configuration of the network is an example. For example, the firmware server 40 or the SNTP server 50 may be arranged in the LAN, or the PC 30 may be arranged on the Internet 3. Further, a plurality of printers 10 or PCs 30 may be connected to the firmware server 40 and the SNTP server 50, the plurality of PCs 30 may be connected to one printer 10, or one PC 30 may select a printer 10 to execute printing from the plurality of printers 10.

The printer 10 is a device capable of executing various processes such as a printing process, and executes various processes in accordance with a print job to be output from the PC 30. The printer 10 mainly includes a controller 11, a user IF 12, a memory 13, a scanner 14, a printing engine 15, a communication IF 16, and a clock 17. IF is an abbreviation of interface. These components can communicate with one another via a bus 18.

The printer 10 can communicate with the router 2 via the communication IF 16. The communication IF 16 is an interface used for communication via the LAN and a WAN. WAN is an abbreviation of Wide Area Network.

The controller 11 includes a CPU, an ASIC (abbreviation of application specific integrated circuit), and the like, and controls operations of the user IF 12, the scanner 14, the printing engine 15, the communication IF 16, and the clock 17. The controller 11 executes a process in accordance with firmware 13A stored in the memory 13. The memory 13 also stores setting information 13B. The memory 13 is implemented by combining a RAM, an NVRAM, a ROM, an SSD, an HDD, and the like. A buffer provided in the controller 11 and used when various programs are executed may also be regarded as a part of the memory 13.

The memory 13 may be a computer-readable storage medium. The computer-readable storage medium is a non-transitory medium. The non-transitory medium also includes a recording medium such as a CD-ROM and a DVD-ROM, in addition to the above-described examples. The non-transitory medium is also a tangible medium. On the other hand, an electric signal conveying a program downloaded from a server or the like on the Internet is a computer-readable signal medium, which is a kind of computer-readable medium, but is not included in the non-transitory computer-readable storage medium.

The user IF 12 is, for example, a touch panel integrated with a display, displays various information such as an operation screen of the printer 10 on the display, and receives a user operation on an icon, a button, or the like displayed on the display. In addition, the user IF 12 may include the display and hard keys separate from the display, other than the touch panel.

The scanner 14 is a portion that includes an image sensor, reads an image, and executes scanning. The printing engine 15 is, for example, an electrophotographic printing mechanism. The printing engine 15 may be an inkjet printing mechanism.

The clock 17 measures a time, and may be implemented by hardware or software, or may be partly implemented as hardware and the rest as software. The clock 17 and the firmware 13A are illustrated separately for convenience, and the controller 11 may execute a process of functioning as the clock 17 in accordance with the firmware 13A. The time measured by the clock 17 is used during a Firmware Update process to be described later with reference to FIG. 10.

The firmware server 40 is a server that provides a latest firmware to the printer 10.

The SNTP server 50 is a server that returns a current time in response to an inquiry about a current time from the printer 10. The printer 10 can synchronize a current time of the clock 17 with the current time received from the SNTP server 50. A server different from the SNTP server 50, for example, an NTP server may be used as the server that returns the current time.

The present specification basically shows processes of the controller 11 according to commands written in programs. That is, the processes such as “judgment”, “extraction”, “selection”, “calculation”, “determination”, “specification”, “acquisition”, “reception”, and “control” to be described below represent the processes of the controller 11. The processes by the controller 11 also include hardware control using API of the OS. In the present specification, the description of the OS is omitted, and an operation of each program is described. That is, in the following description, the description that “a program B controls hardware C” may refer to “the program B controls the hardware C, using the API of the OS”. In addition, the processes of the controller 11 according to the commands written in the programs may be described in omitted words. For example, the processes of the controller 11 may be described as “the CPU performs”. In addition, the processes of the controller 11 according to the commands written in the programs may be described in words in which the controller 11 is omitted, such as “a program A performs”.

The term “acquisition” is used as a concept indicating that a request is not essential. That is, a process of receiving data without a request from the controller 11 is also included in a concept indicating that “the controller 11 acquires data”. In addition, the term “data” in the present specification is represented by a computer-readable bit string. Furthermore, data having substantially the same meaning and different formats are treated as the same data. The same applies to “information” in the present specification. In addition, the term “request” or “instruct” is a concept indicating that information indicating that a request is being made or information indicating that an instruction is being given is output to a partner. In addition, the information indicating that a request is being made or the information indicating that an instruction is being given is simply referred to as a “request” or “instruction”.

According to the controller 11, a process of determining whether information A indicates that it is a matter B may be conceptually described as “determining whether it is the matter B, based on the information A”. According to the controller 11, a process of determining whether the information A indicates that it is the matter B or a matter C may be conceptually described as “determining whether it is the matter B or the matter C, based on the information A”.

The printer 10 can update the firmware by using any one of an Auto Update method (an example of a first method), an Auto Check method (an example of a second method), and a manual method. The Auto Update method is a method of accessing the firmware server 40, downloading firmware from the firmware server 40, and updating the firmware 13A with the downloaded firmware automatically, that is, without an instruction from the user. Similar to the Auto Update method, the Auto Check method is a method of automatically accessing the firmware server 40, but only automatically checking whether a version of latest firmware registered in the firmware server 40 is newer than a version of the firmware 13A, and downloading the firmware from the firmware server 40 and updating the firmware 13A with the downloaded firmware waiting for an instruction from the user. The manual method is a method of accessing the firmware server 40 in response to an instruction from the user. In the present embodiment, a timing at which the printer 10 automatically accesses the firmware server 40 is a timing based on a date and a time slot designated by the user in the Auto Update method, but is a timing that is unique to the printer 10 and is not designated by the user in the Auto Check method.

Here, a setting item Update Method will be described. A setting value of the Update Method is set to any value of Auto Update ON indicating that the Auto Update method is enabled, Auto Check ON indicating that the Auto Check method is enabled, and OFF indicating that neither method is enabled. The setting value of the Update Method can be set at the time of initial installation of the printer 10 and at the time of setting change after the initial installation. FIGS. 2A to 2E illustrate an example of a transition of operation screens displayed on the user IF 12 at the time of the initial installation. The initial installation is a process performed when the user turns the printer 10 on for a first time. The initial installation may be rephrased as a series of initial settings until the printer 10 is made available after the user obtains the printer 10 from a vendor. The initial settings include, for example, a setting of an administrator password, filling of the printing engine 15 with toner or ink, a communication setting of the communication IF 16, and a time setting of the clock 17, in addition to the setting of the setting value of the Update Method.

FIG. 2A illustrates an Auto Update method setting selection screen 100. The Auto Update method setting selection screen 100 is displayed on the user IF 12 at a predetermined timing at the time of the initial installation, for example, at a timing after the communication setting of the communication IF 16 is finished. The Auto Update method setting selection screen 100 is a screen for inquiring of the user whether to set the Auto Update method in order to update the firmware 13A of the printer 10. The Auto Update method setting selection screen 100 displays a notice indicating that the firmware 13A is automatically updated on the printer 10 that is connected to the Internet 3, that is, “the Auto Update method is set,” and “Do you want to continue the setting?” In addition, the Auto Update method setting selection screen 100 also displays a notice indicating that information on the printer 10 is sent to the firmware server 40, with a message “Visit our privacy policy at: https:// . . . ”. Further, the Auto Update method setting selection screen 100 includes a Yes icon 100A for selecting permission to set the Auto Update method and a No icon 100B for selecting not permission to set the Auto Update method. When the Yes icon 100A is operated, the controller 11 sets the setting value of the Update Method to Auto Update ON, sets an update time of the firmware 13A between 19:00 and 20:00 every day from Monday to Friday, and stores the setting value and the update time as the setting information 13B. Then, the Auto Update method setting selection screen 100 is transitioned to an attention calling display screen 101 illustrated in FIG. 2B. When the Auto Update method setting selection screen 100 is switched to the attention calling display screen 101, the controller 11 executes the Auto Update process at the time of the initial installation illustrated in FIG. 3 once.

In the present embodiment, the setting value of the Update Method is OFF by default, but is not limited thereto. The setting value of the Update Method may be Auto Check ON by default. In addition, an EURA permission may be displayed instead of the notice included in the Auto Update method setting selection screen 100 and indicating that the information on the printer 10 is sent to the firmware server 40. EURA is an abbreviation of End-User License Agreement, and is a so-called license agreement.

FIG. 3 illustrates a procedure of the Auto Update process at the time of the initial installation. In FIG. 3, the controller 11 determines in Step (hereinafter, step is described as S) 200 whether it is possible to connect to the firmware server 40. Examples of a state in which it is not possible to connect to the firmware server 40 include a state in which no correct communication setting is made such that the communication IF 16 can communicate with the router 2, and a state in which a communication setting for the communication IF 16 is correct but no user ID is registered in the firmware server 40, and thus it is not possible to connect to the firmware server 40.

When it is determined in S200 that it is possible to connect to the firmware server 40 (S200: YES), the controller 11 inquires of the firmware server 40 whether the firmware 13A needs to be updated (S201). Specifically, the printer 10 sends its own model name and a current version of the firmware 13A to the firmware server 40 using an URL of an inquiry destination. The firmware server 40 compares the version of the latest firmware with the version of the firmware 13A sent from the printer 10. The firmware server 40 stores the latest firmware in association with the model name and the firmware version of the printer 10 to be updated. The model name can also be said to be information indicating a model of the printer. If the latest firmware is newer, the firmware server 40 sends, to the printer 10, the version of the latest firmware and an URL for downloading the latest firmware. On the other hand, if the latest firmware is not newer, that is, if the firmware 13A is the latest version, the firmware server 40 sends, to the printer 10, information indicating that the firmware 13A is the latest firmware. When the URL for downloading the latest firmware is received, the printer 10 can download the version of the latest firmware from the firmware server 40 by accessing the firmware server 40 using the URL. The URL of the inquiry destination may be stored in advance in the printer 10. For example, the URL of the inquiry destination may be stored at the time of manufacturing the printer 10. For example, the URL of the inquiry destination may be stored in the printer 10 by an operation from an administrator of the printer 10. Any information indicating the model of the printer may be used instead of the model name. At this time, the controller 11 causes the user IF 12 to display a firmware checking screen 1071 illustrated in FIG. 4A.

Next, the controller 11 determines whether there is a reply from the firmware server 40 indicating that the firmware 13A needs to be updated (S202). Specifically, it is determined whether the version of the latest firmware and the URL for downloading the latest firmware are received from the firmware server 40. When there is a reply indicating that the firmware 13A needs to be updated (S202: YES), the controller 11 determines whether another function that is not to be executed simultaneously with the Auto Update process is in operation (S203). Examples of the state in which another function that is not to be executed simultaneously with the Auto Update process is in operation include a state in which printing is being performed by the printing engine 15, a state in which scanning is being performed by the scanner 14, a state in which copying is being performed by the scanner 14 and the printing engine 15, and an operation on the user IF 12.

When it is determined in S203 that another function that is not to be executed simultaneously with the Auto Update process is not in operation (S203: NO), the controller 11 downloads a new version of firmware from the firmware server 40 (S204). At this time, the controller 11 transitions the firmware checking screen 1071 of the user IF 12 to a downloading screen 1061 illustrated in FIG. 4B.

Then, when the download of the new version of firmware is finished, the controller 11 rewrites the firmware 13A with the new version of firmware, that is, updates the firmware 13A with the latest firmware (S205). At this time, the controller 11 may transition the display on the user IF 12 to an updating screen 107 illustrated in FIG. 19B to be described later. When the update to the latest firmware is finished, the controller 11 re-activates the printer 10 (S206). That is, the Auto Update process ends. When the printer 10 is re-activated, the controller 11 executes a process in accordance with the updated latest firmware 13A. This process causes the user IF 12 to display a standby screen 102 illustrated in FIG. 2E. The process in accordance with the updated latest firmware 13A may include the Firmware Update process illustrated in FIG. 10 to be described later.

On the other hand, when any one of the case in which it is not possible to connect to the firmware server 40 in S200 (S200: NO), a case in which there is no reply indicating that the firmware 13A needs to be updated in S202 (S202: NO), and a case in which another function is in operation in S203 (S203: YES) is established, the controller 11 ends the Auto Update process without updating the firmware 13A. At this time, when the user IF 12 displays the firmware checking screen 1071, the controller 11 transitions the firmware checking screen 1071 to the attention calling display screen 101 without passing through the downloading screen 1061.

In this way, in the present embodiment, the controller 11 executes the Auto Update process when the Auto Update method setting selection screen 100 is transitioned to the attention calling display screen 101. However, the present disclosure is not limited to this, and at this time, the controller 11 may transition the Auto Update method setting selection screen 100 to the attention calling display screen 101 without executing the Auto Update process.

The attention calling display screen 101 indicates that the firmware 13A is automatically updated between 19:00 and 20:00 every day from Monday to Friday. The attention calling display screen 101 displays a procedure for shifting to a setting screen for changing the update time. Here, the update time includes not only a time but also a date (in the above-described example, every day from Monday to Friday). Further, the attention calling display screen 101 also indicates that, if the printer 10 loses power during an update of the firmware 13A and the firmware 13A becomes corrupted, the printer 10 is connected to the PC 30 with a USB cable to finish the update of the firmware 13A. The attention calling display screen 101 includes an OK icon 101A for approving these attention calling sentences. When the OK icon 101A is operated, the attention calling display screen 101 is transitioned to a standby screen 1021 illustrated in FIG. 2C. The attention calling display screen 101 is an example of a notification screen.

The standby screen 1021 is a so-called HOME screen, and the standby screen 1021 includes an information bar 102A, a Copy icon 102B, a Scan icon 102C, and an All Settings icon 102D. The information bar 102A is a display region for displaying various information. The Copy icon 102B is an icon corresponding to a copy process of causing the printing engine 15 to print scan data read by the scanner 14. When the Copy icon 102B is operated, the controller 11 may display a screen for inputting an instruction to execute the copy process. The screen for inputting an instruction to execute the copy process may also serve as a screen for changing a setting value of the copy process. When the Copy icon 102B is operated, the controller 11 may execute the copy process. The Scan icon 102C is an icon corresponding to a scan process of causing the scanner 14 to read a document to generate and output scan data, for example, storing the scan data in a designated area of the memory 13. When the Scan icon 102C is operated, the controller 11 may display a screen for inputting an instruction to execute the scan process. The screen for inputting an instruction to execute the scan process may also serve as a screen for changing a setting value of the scan process. When the Scan icon 102C is operated, the controller 11 may execute the scan process. The All Settings icon 102D is an icon corresponding to an All Settings screen 110 illustrated in FIG. 6B to be described later. When the All Settings icon 102D is operated, the controller 11 causes the user IF 12 to display the All Settings screen 110.

As illustrated in FIG. 2C, the information bar 102A on the standby screen 1021 displays information indicating that “This machine is using the default . . . ”. “ . . . ” means that a character string following “the default” is omitted. The character string omitted in “ . . . ” is “firmware update settings.”. That is, it is desired to cause the information bar 102A of the standby screen 1021 to display a notice that “This machine is using the default firmware update settings.”, but the display region of the information bar 102A is too small to display the notice, and thus a part of the notice is displayed. The omitted portion may be displayed on the information bar 102A by, for example, automatically scrolling. In this way, the information bar 102A of the standby screen 1021 displays information indicating that the firmware 13A is updated at the default update time by using the Auto Update method in order to notify the user of a state of firmware update settings of the printer 10 after the initial installation.

When the information bar 102A of the standby screen 1021 is operated, the standby screen 1021 is transitioned to an Auto Update method setting information confirmation screen 103 illustrated in FIG. 2D. The Auto Update method setting information confirmation screen 103 displays a notice that the firmware 13A is updated at a default update time by using the Auto Update method. This notice is the same as the notice displayed on the information bar 102A of the standby screen 1021. The Auto Update method setting information confirmation screen 103 also indicates that the default update time is between 19:00 and 20:00 every day from Monday to Friday. Further, the Auto Update method setting information confirmation screen 103 also displays a notice that “Do you want to change these settings?” Further, the Auto Update method setting information confirmation screen 103 includes a Yes icon 103A for selecting to change these settings and a No icon 103B for selecting not to change these settings. When the Yes icon 103A is operated, the Auto Update method setting information confirmation screen 103 is transitioned to a Firmware Update Settings screen 120 illustrated in FIG. 7A to be described later. On the other hand, when the No icon 103B is operated, the Auto Update method setting information confirmation screen 103 is transitioned to the standby screen 102 illustrated in FIG. 2E.

The standby screen 102 is different from the standby screen 1021 illustrated in FIG. 2C in that the information bar 102A is blank. This is because the user knows, via the Auto Update method setting information confirmation screen 103, that the firmware 13A is updated at the default update time by using the Auto Update method, and thus it is not necessary to notify the user again.

In this way, the update time of the firmware 13A is initially set to the default update time, and in the present embodiment, is set to between 19:00 and 20:00 every day from Monday to Friday. When the user wants to change the default update time, the user operates the Yes icon 103A in the Auto Update method setting information confirmation screen 103, so that the user can designate days of the week and a time slot for executing the Auto Update via the user IF 12 as described later with reference to FIGS. 9A and 9B. That is, at the time of the initial installation, first, the user does not need to designate the days of the week and the time slot for executing the Auto Update via the user IF 12. This is because there are many input processes to be required for the user at the time of the initial installation, and thus a load for designating the days of the week and the time slot is not given to the user. In this way, at the time of the initial installation, an input burden on the user, and a load on the printer 10 that receives the input from the user are not increased, and the user can also designate a desired day of the week and time slot as desired at the time of the initial installation. The default days of the week are, for example, Monday to Friday, and the default time slot is, for example, between 19:00 and 20:00. Of course, the default days of the week and time slot are not limited thereto.

In the present embodiment, a timing at which the setting value of the Update Method is set to Auto Update ON at the time of the initial installation and the default days of the week and the time slot are set is a timing at which the Yes icon 100A of the Auto Update method setting selection screen 100 is operated. However, this timing is not limited thereto, and may be, for example, a timing at which the No icon 103B of the Auto Update method setting information confirmation screen 103 is operated. Therefore, in this case, while the user IF 12 displays the Auto Update method setting information confirmation screen 103 from the Auto Update method setting selection screen 100 passing through the attention calling display screen 101 and the standby screen 1021, the setting value of the Update Method remains at the default OFF.

Instead of the Auto Update method setting selection screen 100 illustrated in FIG. 2A, an Auto Update method setting selection screen 1000 illustrated in FIG. 4C may be adopted. The Auto Update method setting selection screen 1000 includes a Yes icon 1000A for selecting permission to set the Auto Update method and a No icon 1000B for selecting not permission to set the Auto Update method. When the Yes icon 1000A is operated, the controller 11 sets the setting value of the Update Method to Auto Update ON, sets an update time of the firmware 13A between 19:00 and 20:00 every day from Monday to Friday, and stores the setting value and the update time as the setting information 13B. Then, the Auto Update method setting selection screen 1000 is transitioned to an attention calling display screen 1001 illustrated in FIG. 4D.

The attention calling display screen 1001 displays an attention calling sentence “Do not turn the printer off during the Firmware Update. Visit our privacy policy for details at: https:// . . . ” and an OK icon 1001A for approving the attention calling sentence. When the OK icon 1001A is operated, the attention calling display screen 1001 is transitioned to the attention calling display screen 101 illustrated in FIG. 2B. The attention calling display screen 1001 may be transitioned to the standby screen 1021 illustrated in FIG. 2C without being transitioned to the attention calling display screen 101 illustrated in FIG. 2B.

When the Yes icon 1000A on the Auto Update method setting selection screen 1000 is operated, the controller 11 may transition the Auto Update method setting selection screen 1000 to the attention calling display screen 101 illustrated in FIG. 2B instead of the attention calling display screen 1001. Further, when the Yes icon 1000A on the Auto Update method setting selection screen 1000 is operated, the controller 11 may transition the Auto Update method setting selection screen 1000 to the standby screen 1021 illustrated in FIG. 2C.

As described above, when the setting value of the Update Method is set to Auto Update ON at the time of the initial installation and the default days of the week and the time slot are set, the controller 11 determines an access time for firmware update. The access time for the firmware update is a time at which a firmware update process of accessing the firmware server 40, downloading firmware to be updated from the firmware server 40, and updating the firmware 13A with the downloaded firmware is started. The determined access time for the firmware update is stored as the setting information 13B. FIG. 5 is a diagram illustrating a process of determining an access time for firmware update. An “Auto Update execution time slot” indicates a time slot stored in the setting information 13B. If this time slot is, for example, between 19:00 and 20:00, an Auto Update start time T1 is 19:00 and an Auto Update end time T2 is 20:00. The controller 11 sets, as an end time T3 of an “Auto Update startable time slot”, a time earlier than the Auto Update end time T2 by a length of time estimated to be required for updating the firmware (illustrated as “estimated Firm Update time length”). Here, the estimated Firm Update time length is obtained by estimating a maximum value of a time from when the controller 11 accesses the firmware server 40 to when the controller 11 downloads the firmware from the firmware server 40 and updates the firmware 13A with the downloaded firmware. If the start time of the Auto Update startable time slot is the start time T1 of the Auto Update execution time slot, the Auto Update startable time slot is a time slot from the time T1 to the time T3. If the estimated Firm Update time length is, for example, 10 minutes, the end time T3 of the Auto Update startable time slot is 17:50.

If the controller 11 accesses the firmware server 40 at a time included in the Auto Update startable time slot, the update of the firmware 13A is finished until the end time T2 of the Auto Update execution time slot. Specifically, if the access time to the firmware server 40 is determined to be a time T4 included in the Auto Update startable time slot, the update of the firmware 13A is finished until the end time T2 of the Auto Update execution time slot. The controller 11 randomly determines the access time for the firmware update to be a time included in the Auto Update startable time slot. The random determination method may be a method using a random number. The random determination method may be a method using a random function. The firmware server 40 existing on the Internet is accessed from a large number of printers 10. It is possible to prevent concentration of access at the same access time by randomly determining the access time in the large number of printers 10. That is, it is possible to reduce problems such as delay in the processes of the firmware server 40 due to the concentrated access.

On the other hand, when the No icon 100B is operated on the Auto Update method setting selection screen 100 illustrated in FIG. 2A, the Auto Update method setting selection screen 100 is transitioned to the standby screen 102 illustrated in FIG. 2E without passing through the attention calling display screen 101. At this time, the setting value of the Update Method is maintained to be OFF which is a default value. When the Yes icon 100A is selected on the Auto Update method setting selection screen 100, the Auto Update method setting selection screen 100 may be transitioned to the standby screen 1021 illustrated in FIG. 2C without displaying the attention calling display screen 101, and the setting value of the Update Method may be set to Auto Update ON.

At the time of the setting change after the initial installation, as will be described later with reference to FIGS. 6A to 6C, the setting value of the Update Method can be freely set to any of Auto Update ON, Auto Check ON, and OFF. On the other hand, only Auto Update ON can be set at the time of the initial installation. This is also because a load for selecting which of the Auto Update method and the Auto Check method is enabled is not given to the user. In this way, the input burden on the user at the time of the initial installation and the load on the printer 10 that receives the input from the user are not increased, and the user can set any one of the desired Auto Update method, Auto Check method, and manual method after the initial installation.

Next, the setting of the setting value or the like of the Update Method performed at the time of the setting change after the initial installation will be described. FIGS. 6A to 6C illustrate an example of a transition of operation screens displayed on the user IF 12 at the time of the setting change after the initial installation. FIG. 6A illustrates the same standby screen 102 as the standby screen 102 in FIG. 2E. When the All Settings icon 102D is operated on the standby screen 102, the standby screen 102 is transitioned to the All Settings screen 110 illustrated in FIG. 6B.

The All Settings screen 110 displays a plurality of setting items. When a Machine Info. item 110A is operated from among the setting items, the All Settings screen 110 is transitioned to a Machine Info. screen 111 illustrated in FIG. 6C. When the Firmware Update Settings item 111A is operated from the Machine Info. screen 111, the Machine Info. screen 111 is transitioned to one of Firmware Update Settings screens 120, 120′, and 120″ respectively illustrated in FIGS. 7A to 7C.

The Firmware Update Settings screen 120 illustrated in FIG. 7A is a screen that transitions when the setting value of the Update Method is Auto Update ON, the Firmware Update Settings screen 120′ illustrated in FIG. 7B is a screen that transitions when the setting value of the Update Method is Auto Check ON, and the Firmware Update Settings screen 120″ illustrated in FIG. 7C is a screen that transitions when the setting value of the Update Method is OFF. The setting value of the Update Method is stored in the memory 13 as the setting information 13B as described above, and thus the controller 11 transitions the display of the user IF 12 from the Machine Info. screen 111 to any one of the Firmware Update Settings screens 120, 120′, and 120″ based on the setting value of the Update Method read from the memory 13.

The Firmware Update Settings screen 120 illustrated in FIG. 7A displays an Update Method item 120A, a Days Of Week item 120B, and a Time Slot item 120C. The Update Method item 120A is for designating the firmware update method, and the Update Method item 120A displays Auto Update, which is a currently set update method. The Days Of Week item 120B is for designating the days of the week for executing the Auto Update, and the Days Of Week item 120B displays Monday to Friday, which are currently set days of the week. The Time Slot item 120C is for designating a time slot during which the Auto Update is executed, and the Time Slot item 120C displays a currently set time slot from 19:00 to 20:00. The days of the week displayed in the Days Of Week item 120B and the time slot displayed in the Time Slot item 120C in FIG. 7A are default values. That is, the days of the week and the time slot are automatically set days of the week and time slot when Auto Update ON is set at the time of the initial installation.

When the Update Method item 120A included in the Firmware Update Settings screen 120 is operated, the Firmware Update Settings screen 120 is transitioned to an Update Method setting screen 130 illustrated in FIG. 8A. The Update Method setting screen 130 displays items 130A to 130C indicating a plurality of update methods that can be designated. When the item 130A indicating the Auto Update method is operated among the items, the Update Method setting screen 130 is transitioned to an Auto Update method setting confirmation screen 140 illustrated in FIG. 8B. When the item 130A indicating the Auto Update method is operated, the controller 11 may maintain a current setting value of the Update Method if the current setting value of the Update Method indicates Auto Update ON. In this case, the controller 11 may not cause the user IF 12 to display the Auto Update method setting confirmation screen 140.

The Auto Update method setting confirmation screen 140 displays a warning that the firmware is automatically updated when the Auto Update method is selected and enabled. This is because when the Auto Update method is enabled, the firmware is automatically updated without an instruction input, and thus the user is warned of the update.

When a Yes icon 140A included in the Auto Update method setting confirmation screen 140 is operated, the Auto Update method setting confirmation screen 140 is transitioned to an attention calling display screen 1011 illustrated in FIG. 8C. When an OK icon 1011A included in the attention calling display screen 1011 is operated, the controller 11 sets the setting value of the Update Method to Auto Update ON and stores the same in the setting information 13B. The attention calling display screen 1011 is transitioned to the Firmware Update Settings screen 120 illustrated in FIG. 7A. At this time, the controller 11 determines the access time to the firmware server 40 and stores the determined access time in the setting information 13B. The details of the process of determining an access time have been described above with reference to FIG. 5, and thus will not be described again here.

On the other hand, when a No icon 140B included in the Auto Update method setting confirmation screen 140 is operated, the Auto Update method setting confirmation screen 140 returns to any one of the Firmware Update Settings screens 120, 120′, and 120″ before being transitioned to the Update Method setting screen 130.

On the other hand, when the item 130B indicating the Auto Check method is operated on the Update Method setting screen 130, the Update Method setting screen 130 is transitioned to an Auto Check method setting confirmation screen 150 illustrated in FIG. 8D.

When a Yes icon 150A included in the Auto Check method setting confirmation screen 150 is operated, the controller 11 sets the setting value of the Update Method to Auto Check ON and stores the same in the setting information 13B. The firmware is not automatically updated even if the Auto Check method is selected and enabled, and thus the Auto Check method setting confirmation screen 150 does not display the warning displayed on the Auto Update method setting confirmation screen 140. In this way, depending on whether the Auto Update method, which does not require input of an instruction, or the Auto Check method, which requires input of an instruction, is enabled for the firmware update, a warning about the automatic update can be displayed appropriately. The Auto Check method setting confirmation screen 150 is transitioned to the Firmware Update Settings screen 120′ illustrated in FIG. 7B. When the item 130B indicating the Auto Check method is operated, the controller 11 may maintain the current setting value of the Update Method if the current setting value of the Update Method indicates Auto Check ON. In this case, the controller 11 may not cause the user IF 12 to display the Auto Check method setting confirmation screen 150. Here, the Firmware Update Settings screen 120′ displays an Update Method item 120′A, but the Days Of Week item and the Time Slot item are grayed out. That is, the Days Of Week item and the Time Slot item being grayed out indicate that the Days Of Week item and the Time Slot item cannot be operated when the setting value of the Update Method is Auto Check ON. That is, unlike the case in which the firmware is updated by using the Auto Update method, when the firmware is updated by using the Auto Check method, the user cannot determine a timing for updating firmware.

On the other hand, when a No icon 150B included in the Auto Check method setting confirmation screen 150 is selected, the Auto Check method setting confirmation screen 150 returns to any one of the Firmware Update Settings screens 120, 120′, and 120″ before being transitioned to the Update Method setting screen 130.

Further, when the item 130C indicating OFF is operated on the Update Method setting screen 130, the controller 11 sets the setting value of the Update Method to OFF and stores the same in the setting information 13B. Then, the Update Method setting screen 130 is transitioned to the Firmware Update Settings screen 120″ illustrated in FIG. 7C. The Firmware Update Settings screen 120″ also displays an Update Method item 120″A, but the Days Of Week item and the Time Slot item are grayed out. The Update Method item 120″A displays OFF indicating that the setting value of the Update Method is OFF. In this way, the Days Of Week item and the Time Slot item being grayed out indicate that the Days Of Week item and the Time Slot item cannot be operated when the setting value of the Update Method is OFF, that is, when the firmware is updated by using the manual method.

On the other hand, when the Days Of Week item 120B is operated on the Firmware Update Settings screen 120, the Firmware Update Settings screen 120 is transitioned to a Days Of Week setting screen 160 illustrated in FIG. 9A. On the Days Of Week setting screen 160, the user can designate days of the week by displaying the days of the week while operating an up icon 160A and a down icon 160B and operating check boxes 160C provided adjacent to the days of the week. The Days Of Week setting screen 160 displays, with check marks, the check boxes 160C adjacent to the currently set days of the week, that is, the days of the week stored in the setting information 13B of the memory 13. Therefore, the user can designate days of the week for setting change while referring to the currently set days of the week. When the designation of the days of the week is finished and an OK icon 160D is operated, the days of the week on which the firmware server 40 is accessed to update the firmware are determined, and the Days Of Week setting screen 160 returns to the Firmware Update Settings screen 120. At this time, the controller 11 stores the designated days of the week in the setting information 13B in association with Auto Update ON.

On the other hand, when the Time Slot item 120C is operated on the Firmware Update Settings screen 120, the Firmware Update Settings screen 120 is transitioned to a Time Slot setting screen 170 illustrated in FIG. 9B. On the Time Slot setting screen 170, a time slot is designated by inputting a start time and an end time using a delete icon 170B and a numeric keypad 170E while moving a position of a cursor (not illustrated) displayed in a time slot setting region 170A by a left movement icon 170C and a right movement icon 170D. On the Time Slot setting screen 170, as in the Days Of Week setting screen 160, the time slot setting region 170A displays the currently set time slot, that is, the time slot stored in the setting information 13B of the memory 13. Therefore, the user can designate the time slot for setting change based on the currently set time slot. In the present embodiment, the time slot can be designated in units of hours, not in units of minutes, but may be designated in units of minutes. In this way, the time slot for executing the Firmware Update is designated in order to distribute a load due to the simultaneous access to the firmware server 40. On the Time Slot setting screen 170, the time slot can be designated in units of hours, but the user can designate a time slot by inputting any time, and thus can perform an input for designating a night time slot, an input for designating a day time slot, an input for designating an early morning time slot, and an input for designating an evening time slot. When the designation of the time slot is finished and an OK icon 170F is operated, the time slot for accessing the firmware server 40 to update the firmware is determined, and the Time Slot setting screen 170 returns to the Firmware Update Settings screen 120. At this time, the controller 11 stores the designated time slot in the setting information 13B in association with Auto Update ON.

Next, the Firmware Update process executed by the printer 10, particularly by the controller 11, will be described with reference to FIG. 10. FIG. 10 is a flowchart illustrating the process performed by the controller 11 in accordance with the firmware 13A after the initial installation, focusing on the Auto Update process of updating the firmware 13A by using the Auto Update method and the Auto Check process of updating the firmware 13A by using the Auto Check method, while omitting other processes. Of course, the printer 10 executes a process in accordance with the firmware 13A every time the printer 10 is activated.

In FIG. 10, the controller 11 determines in S1 whether the setting value of the Update Method indicates Auto Update ON, Auto Check ON, or OFF. It can be said that the setting value indicating Auto Update ON is a setting value indicating that the Auto Update method is enabled. Further, it can be said that the setting value indicating Auto Check ON is a setting value indicating that the Auto Check method is enabled. It can be said that the setting value indicating OFF is a setting value indicating that both the Auto Update method and the Auto Check method are disabled. It can also be said that the setting value indicating OFF is a setting value indicating that the manual method is enabled. The setting value of the Update Method is stored in the memory 13 as the setting information 13B as described above, and thus the controller 11 determines in S1 whether the setting value of the Update Method indicates any one of Auto Update ON, Auto Check ON, and OFF based on the setting value of the Update Method read out from the memory 13.

When it is determined in S1 that the setting value of the Update Method indicates Auto Update ON (S1: Auto Update ON), the controller 11 determines whether the setting of the clock 17 is finished (S2). The clock 17 after the setting is finished may be in a variety of settings. For example, in a situation in which the printer 10 can access the SNTP server 50 as in the image forming system 1, the clock 17 may be manually set for time without selecting to access the SNTP server 50. In such a situation, it is possible to select to access the SNTP server 50 and synchronize the time of the clock 17 with the SNTP server 50. Further, the time measured by the clock 17 is not displayed on the user IF 12, and the clock 17 may be operating inside the printer 10. Even in this state, the time setting of the clock 17 may be performed manually or using the SNTP server 50.

When it is determined in S2 that the setting for the clock 17 is finished (S2: YES), the controller 11 executes the Auto Update process (S3) and then returns the process to S1.

FIG. 11 illustrates a detailed procedure of the Auto Update process. An outline of the Auto Update process will be described before the details of the Auto Update process are described. In the Auto Update process, the firmware 13A is mainly updated by using the Auto Update method, and a pre-notification and an immediate pre-notification are performed before the firmware 13A is actually updated. FIGS. 18A to 18C illustrate an example of a transition of display screens in the Auto Update process. The standby screen 102 illustrated in FIG. 18A is the same screen as the standby screen 102 illustrated in FIG. 2E. In the standby screen 102, the firmware 13A is selected to be updated at the default update time by using the Auto Update method. In the present embodiment, as described above, the default update time is set between 19:00 and 20:00 every day from Monday to Friday. Then, if, for example, the access time for the firmware update is set at 19:30, the user IF 12 displays a pre-notification from 7:30, which is 12 hours before 19:30. FIG. 18B illustrates a pre-notification screen 104 as an example of a pre-notification screen. Then, the user IF 12 displays an immediate pre-notification from 19:20, which is 10 minutes before 19:30. FIG. 18C illustrates an immediate pre-notification screen 105 as an example of an immediate pre-notification screen.

In this way, by displaying the pre-notification screen 104 and the immediate pre-notification screen 105, the user is notified that the firmware 13A will be automatically updated before the firmware 13A is actually updated, and thus a situation in which the firmware 13A is unexpectedly updated without the user's knowledge is avoided.

As illustrated in FIG. 11, the Auto Update process includes an update monitoring timing setting process (S10), an updated firmware check process (S11), a pre-notification request write process (S12), an immediate pre-notification request write process (S13), and an update execution process (S14).

FIG. 12 illustrates a detailed procedure of the update monitoring timing setting process in S10. The update monitoring timing setting process is a process of setting a monitoring timing for inquiring of the firmware server 40 whether there is firmware to be updated.

In FIG. 12, the controller 11 determines whether an update monitoring timing needs to be newly set (S20). Examples of the case in which the update monitoring timing needs to be newly set include a case in which the printer 10 is turned on and a case in which the setting value of the Update Method is switched from a case other than a case in which the setting value indicates Auto Update ON to the case in which the setting value indicates Auto Update ON. When it is determined in S20 that the update monitoring timing needs to be newly set (S20: YES), the controller 11 sets the new update monitoring timing (S21) and then ends the update monitoring timing setting process.

When the printer 10 is turned on and “YES” is determined in S20, the controller 11 sets the new update monitoring timing, for example, to a random time between 3 minutes and 6 minutes after the printer 10 is turned on. A method of obtaining a random time may be the method using a random number or the method using a random function. In this way, The reason why the new update monitoring timing is set to the random time is to prevent the access to the firmware server 40 from being concentrated even if the large number of printers 10 are turned on at the same time.

On the other hand, when the setting value of the Update Method is switched from the case other than the case in which the setting value indicates Auto Update ON to the case in which the setting value indicates Auto Update ON, and “YES” is determined in S20, the controller 11 sets the new update monitoring timing, for example, to a current time. In this way, the reason why the new update monitoring timing is set to the current time is that it is rare for the setting value of the Update Method to be switched at the same time from the case other than the case in which the setting value indicates Auto Update ON to the case in which the setting value indicates Auto Update ON, even if there are the large number of printers 10.

On the other hand, when it is determined in S20 that the update monitoring timing does not need to be newly set (S20: NO), the controller 11 ends the update monitoring timing setting process.

FIG. 13 illustrates a detailed procedure of the updated firmware check process in S11. The updated firmware check process is mainly a process of inquiring of the firmware server 40 whether there is firmware to be updated at the update monitoring timing.

In FIG. 13, the controller 11 determines whether the current time matches the update monitoring timing (S30). When it is determined that the current time matches the update monitoring timing (S30: YES), the controller 11 updates the update monitoring timing to a next update monitoring timing (S31). The next update monitoring timing is, for example, 24 hours after the update monitoring timing before the update. Therefore, when an initial update monitoring timing is set in the update monitoring timing setting process, the next update monitoring timing is 24 hours after the initial update monitoring timing. Thereafter, the update monitoring timing is updated every 24 hours. The update monitoring timing is irrelevant to the access time for the firmware update, and the firmware server 40 is accessed at different timings.

Next, the controller 11 determines whether it is possible to connect to the firmware server 40 (S32). Examples of the state in which it is not possible to connect to the firmware server 40 include the state in which no correct communication setting is made such that the communication IF 16 can communicate with the router 2, and the state in which a communication setting for the communication IF 16 is correct but the user ID is not registered in the firmware server 40, and thus it is not possible to connect to the firmware server 40.

When it is determined in S32 that it is possible to connect to the firmware server 40 (S32: YES), the controller 11 inquires of the firmware server 40 whether there is firmware with which the firmware 13A is to be updated (S33). As a specific method of the inquiry, a method similar to the method described in the inquiry of S201 (see FIG. 3) may be used, and thus the description thereof is omitted.

Next, the controller 11 determines whether there is firmware to be updated in the firmware server 40 based on a response from the firmware server 40 to the inquiry (S34). When it is determined that there is firmware to be updated (S34: YES), the controller 11 executes a pre-notification timing and immediate pre-notification timing setting process (S35), and then ends the updated firmware check process.

On the other hand, when it is determined in S30 that the current time does not match the update monitoring timing (S30: NO), when it is determined in S32 that it is not possible to connect to the firmware server 40 (S32: NO), or when it is determined in S34 that there is no firmware to be updated (S34: NO), the controller 11 ends the updated firmware check process.

FIG. 14 illustrates a detailed procedure of the pre-notification timing and immediate pre-notification timing setting process in S35. In the pre-notification timing and immediate pre-notification timing setting process, the controller 11 sets or does not set a pre-notification timing and an immediate pre-notification timing in the following cases. That is, in a case (Case 1) in which the current time is before a pre-notification time (S40: YES): the pre-notification timing is set to the pre-notification time (S41) and an immediate pre-notification timing is set to the immediate pre-notification time (S46), in a case (Case 2) in which the current time is after the pre-notification time and before an update avoidance time (S40: NO and S42: YES): the pre-notification timing is set to the current time (S45) and the immediate pre-notification timing is set to the immediate pre-notification time (S46), and in a case (Case 3) in which the current time is after the update avoidance time (S42: NO): a next access time for firmware update is set without setting both the pre-notification timing and the immediate pre-notification timing (S47).

Here, the current time is a time when “YES” is determined in the determination of S33. The pre-notification time is a time that is 12 hours before the access time for the firmware update. The immediate pre-notification time is a time that is 10 minutes before the access time for the firmware update. The update avoidance time is a time that is 1 hour before the access time for the firmware update. Even if it is found in the updated firmware check process that there is firmware to be updated in the firmware server 40 at the update avoidance time (S34: YES), if the found time point is too close to the access time for the firmware update (for example, one hour before), there is a possibility that the firmware 13A is unexpectedly updated by the user. Therefore, when it is determined that the time when it is found that there is firmware to be updated in the firmware server 40 is too close to the access time for the firmware update, the update avoidance time is set in order to avoid the firmware from being updated at the current access time and update the firmware at the next access time. Specific times such as 12 hours, 10 minutes, and 1 hour are merely examples, and other times may be adopted. However, it is preferred that there is a magnitude relation of a time (12 hours) from the access time for the firmware update to the pre-notification time>a time (1 hour) from the access time to the update avoidance time>a time (10 minutes) from the access time to the immediate pre-notification time.

FIG. 15A illustrates a detailed procedure of the pre-notification request write process of S12. In FIG. 15A, the controller 11 determines whether the current time matches the pre-notification timing (S50), and when the current time matches the pre-notification timing (S50: YES), the controller 11 writes a pre-notification request in a predetermined area of the memory 13 (S51), and then ends the pre-notification request write process. On the other hand, when the current time does not match the pre-notification timing (S50: NO), the controller 11 ends the pre-notification request write process.

FIG. 15B illustrates a detailed procedure of the immediate pre-notification request write process of S13. In FIG. 15B, the controller 11 determines whether the current time matches the immediate pre-notification timing (S60), and when the current time matches the immediate pre-notification timing (S60: YES), the controller 11 writes an immediate pre-notification request in the predetermined area of the memory 13 (S61), and then ends the immediate pre-notification request write process. On the other hand, when the current time does not match the immediate pre-notification timing (S60: NO), the controller 11 ends the immediate pre-notification request write process.

The predetermined area of the memory 13 to which the pre-notification request and the immediate pre-notification request are written is the same area and is referred to by the user IF 12. When the pre-notification request is written to the predetermined area of the memory 13, the user IF 12 displays the pre-notification screen 104 illustrated in FIG. 18B. On the other hand, when the immediate pre-notification request is written in the same area, the user IF 12 displays the immediate pre-notification screen 105 illustrated in FIG. 18C. The area transitions from a state in which neither the pre-notification request nor the immediate pre-notification request is written to a state in which the pre-notification request is written, and then transitions to a state in which the immediate pre-notification request is written. Therefore, the user IF 12 continuously displays the pre-notification screen 104 from the pre-notification timing to the immediate pre-notification timing, and continuously displays the immediate pre-notification screen 105 from the immediate pre-notification timing to the access time for the firmware update.

Conversely, when neither the pre-notification request nor the immediate pre-notification request is written to the predetermined area of the memory 13, neither the pre-notification screen 104 nor the immediate pre-notification screen 105 is displayed on the user IF 12. Therefore, when the current time is after the update avoidance time, neither the pre-notification timing nor the immediate pre-notification timing is set, and thus neither the pre-notification screen 104 nor the immediate pre-notification screen 105 is displayed on the user IF 12. Similarly, when the pre-notification timing and immediate pre-notification timing setting process is not executed, neither the pre-notification timing nor the immediate pre-notification timing is set, and thus neither the pre-notification screen 104 nor the immediate pre-notification screen 105 is displayed on the user IF 12. Therefore, when it is determined as “NO” in S34 of FIG. 13, that is, when the firmware server 40 does not have firmware to be updated, the pre-notification timing and immediate pre-notification timing setting process is not executed, and thus neither the pre-notification timing nor the immediate pre-notification timing is set, and neither the pre-notification screen 104 nor the immediate pre-notification screen 105 is displayed on the user IF 12.

FIG. 16 illustrates a detailed procedure of the update execution process in S14. In FIG. 16, the controller 11 determines whether the current time matches the access time for the firmware update (S70). When it is determined that the current time matches the access time for the firmware update (S70: YES), the controller 11 determines whether there is the immediate pre-notification request written to the predetermined area of the memory 13 (S71). The case in which the immediate pre-notification request is written corresponds to the case in which there is firmware to be updated in the firmware server 40. Therefore, the determination in S71 corresponds to the determination as to whether there is firmware to be updated in the firmware server 40.

When it is determined in S71 that the immediate pre-notification request is written to the predetermined area of the memory 13 (S71: YES), the controller 11 determines whether print data for accumulated printing (an example of specific print data) is stored in a volatile memory (S72). When it is determined that the print data for accumulated printing is stored in the volatile memory (S72: YES), the controller 11 ends the update execution process. On the other hand, when no print data for accumulated printing is stored in the volatile memory (S72: NO), the controller 11 advances the process to S73.

The accumulated printing is printing in which unprinted print data based on a print job received from an external device such as the PC 30 or a smartphone is accumulated in the memory 13, and when an instruction is received via the user IF 12, the accumulated print data is printed. The memory 13 includes a rewritable volatile memory such as a RAM and a rewritable non-volatile memory such as an NVRAM. The firmware 13A or the setting information 13B is stored in the rewritable non-volatile memory. The print data for accumulated printing is stored in the rewritable volatile memory. When the process proceeds from S75 to S76 (to be described later) and the printer 10 is re-activated, no data stored before the reactivation remains in the volatile memory. In the Auto Update process, when the access time for the firmware update arrives, the process may automatically proceed from S75 to S76 without being noticed by the user. That is, there is a possibility that the print data disappears from the memory 13 without being printed before being noticed by the user. Therefore, a possibility that the print data disappears from the memory 13 can be reduced by adding a determination step shown in S72 as to whether the print data for accumulated printing is stored in the volatile memory.

The print data for accumulated printing may also be stored in the non-volatile memory. The non-volatile memory may be an external memory such as a USB memory attached to the printer 10. In this configuration, even if the print data for accumulated printing is stored in the non-volatile memory, if the print data for accumulated printing is not stored in the volatile memory, it may be determined as “NO” in S72. In addition, a configuration may be adopted in which when the printer 10 is re-activated, the print data for accumulated printing stored in the non-volatile memory cannot be printed before the reactivation. In this configuration, when the print data for accumulated printing is stored in the non-volatile memory, it may be determined as “YES” in S72.

The controller 11 determines in S73 whether another function that is not to be executed simultaneously with the update execution process is in operation. Examples of the state in which the other function that is not to be executed simultaneously with the update execution process is in operation include a state in which printing is being performed by the printing engine 15, a state in which scanning is being performed by the scanner 14, a state in which copying is being performed by the scanner 14 and the printing engine 15, and an operation on the user IF 12.

When it is determined in S73 that the other function that is not to be executed simultaneously with the update execution process is not in operation (S73: NO), the controller 11 downloads a new version of firmware to be updated from the firmware server 40 (S74). At this time, the controller 11 transitions the immediate pre-notification screen 105 displayed on the user IF 12 to the downloading screen 106 illustrated in FIG. 19A. The same process as S200 in FIG. 3 may be added before the download process in S74. That is, the controller 11 may determine whether it is possible to connect to the firmware server 40, and if it is not possible to connect to the firmware server 40, proceed to S78. This is because the same determination as in S200 is performed in S32 (see FIG. 13) of the updated firmware check process before the update execution process is executed, but it is also assumed that it is possible to connect to the firmware server 40 from when the controller 11 makes the determination in S32 to when the controller 11 executes the download process in S74. In addition, the same process as S203 in FIG. 3 may be added before the download process in S74. That is, the controller 11 may determine whether the other function that is not to be executed simultaneously with the Auto Update process is in operation, and if the other function is in operation, proceed to S78. In addition, it is determined in S71 whether the server has the firmware to be updated based on “whether the immediate pre-notification request is written”, this determination may be omitted, and the same process as S203 in FIG. 3 may be added before the download process in S74. That is, the controller 11 may determine whether the firmware needs to be updated, and if the firmware does not need to be updated, proceed to S78.

Then, when the download of the new version of firmware is finished, the controller 11 rewrites the firmware 13A with the new version of firmware, that is, updates the firmware 13A with the latest firmware (S75). At this time, the controller 11 transitions the display of the user IF 12 to the updating screen 107 in FIG. 19B. When the update to the latest firmware is finished, the controller 11 re-activates the printer 10 (S76). When the printer 10 is re-activated, the controller 11 executes the process in accordance with the updated latest firmware 13A.

When the reactivation in S76 ends, the controller 11 executes a process in S77, and causes the info bar 102A of the standby screen 1022 to indicate that the firmware is updated as illustrated in FIG. 19C. When the information bar 102A is operated in a state in which the message indicating that the firmware is updated is displayed, the controller 11 displays an update execution finish confirmation screen 180 illustrated in FIG. 19D. Then, when an OK icon 180A included in the update execution finish confirmation screen 180 is operated, the controller 11 displays the standby screen 102 illustrated in FIG. 18A.

Next, the controller 11 determines a next access time for firmware update (S78). The determined time is stored in the setting information 13B. The details of the process of determining an access time have been described above with reference to FIG. 5, and thus will not be described again here.

Next, the controller 11 erases the writing of the immediate pre-notification request in the predetermined area of the memory 13 (S79), and then ends the update execution process.

On the other hand, when it is determined in S70 that the current time does not match the access time for the firmware update (S70: NO), when it is determined in S71 that the immediate pre-notification request is not written (S71: NO), or when it is determined in S73 that the other function that is not to be executed simultaneously with the update execution process is in operation (S73: YES), the controller 11 advances the process to S78, executes the processes of S78 and S79, and then ends the update execution process. When the update execution process ends, the Auto Update process of S3 (see FIG. 10) is finished.

Further, a flow from when the controller 11 determines “YES” in S34 and detects that there is firmware to be updated in the firmware server 40 to when the controller 11 finishes the update of the firmware 13A with firmware to be updated actually will be described for each of the above-described cases, that is, (Case 1) to (Case 3).

When (Case 1) is established, the user IF 12 displays the standby screen 102 in FIG. 18A until the current time becomes the pre-notification time. Then, when the current time becomes the pre-notification time, the standby screen 102 of the user IF 12 is transitioned to the pre-notification screen 104 in FIG. 18B.

The pre-notification screen 104 indicates that new firmware is available and that the firmware will be automatically updated between 19:00 and 20:00. In addition, the pre-notification screen 104 also indicates that do not turn the printer 10 off, and if you do not want to update the firmware, press “Cancel Update”. Further, the pre-notification screen 104 displays an OK icon 104A and a Cancel Update icon 104B.

When the OK icon 104A is operated, the pre-notification screen 104 of the user IF 12 is transitioned to the standby screen 102. At this time, the automatic update of the firmware at the current access time for the firmware update is not canceled. Therefore, when the current time becomes the immediate pre-notification time, the standby screen 102 of the user IF 12 is transitioned to the immediate pre-notification screen 105 in FIG. 18C.

On the other hand, when the Cancel Update icon 104B is operated, similarly, the pre-notification screen 104 of the user IF 12 is transitioned to the standby screen 102. However, in this case, the automatic update of the firmware at the current access time for the firmware update is canceled, and the automatic update of the firmware at the next access time for the firmware update is scheduled.

After the pre-notification screen 104 is displayed, if neither the OK icon 104A nor the Cancel Update icon 104B is operated, the pre-notification screen 104 of the user IF 12 continues to be displayed, and when the current time becomes the immediate pre-notification time, the pre-notification screen 104 of the user IF 12 is transitioned to the immediate pre-notification screen 105.

The immediate pre-notification screen 105 indicates that new firmware is available and that the firmware will be automatically updated soon. Similar to the pre-notification screen 104, the immediate pre-notification screen 105 also indicates that do not turn the printer 10 off, and if you do not want to update the firmware, press “Cancel Update”. Further, the immediate pre-notification screen 105 displays an OK icon 105A and a Cancel Update icon 105B.

When the OK icon 105A is operated, the immediate pre-notification screen 105 of the user IF 12 is transitioned to the standby screen 102. At this time, the automatic update of the firmware at the current access time for the firmware update is not canceled. Therefore, when the current time becomes the current access time for the firmware update, the firmware is automatically updated. Accordingly, the standby screen 102 of the user IF 12 is transitioned to the downloading screen 106 in FIG. 19A, is transitioned to the updating screen 107 in FIG. 19B, and then is transitioned to the standby screen 1022 in FIG. 19C.

On the other hand, when the Cancel Update icon 105B is operated, similarly, the immediate pre-notification screen 105 of the user IF 12 is transitioned to the standby screen 102. However, in this case, the automatic update of the firmware at the current access time for the firmware update is canceled, and the automatic update of the firmware at the next access time for the firmware update is scheduled.

If neither the OK icon 105A nor the Cancel Update icon 105B is operated after the immediate pre-notification screen 105 is displayed, the immediate pre-notification screen 105 of the user IF 12 continues to be displayed, and when the current time becomes the current access time for the firmware update, the firmware is automatically updated. Accordingly, the immediate pre-notification screen 105 of the user IF 12 is transitioned to the downloading screen 106 in FIG. 19A, is transitioned to the updating screen 107 in FIG. 19B, and then is transitioned to the standby screen 1022 in FIG. 19C.

When (Case 2) is established, the user IF 12 displays the pre-notification screen 104 in FIG. 18B. The screen transition on the user IF 12 thereafter is the same as that when (Case 1) is established, and the description thereof is omitted.

When (Case 3) is established, the standby screen 102 of the user IF 12 continues to be displayed regardless of whether the current time matches the immediate pre-notification time or the current access time for the firmware update, the automatic update of the firmware at the current access time for the firmware update is canceled, and the automatic update of the firmware at the next access time for the firmware update is scheduled.

Returning to FIG. 10, when it is determined in S1 that the setting value of the Update Method indicates Auto Check ON (S1: Auto Check ON), the controller 11 determines whether it is a start timing of Auto Check (S5). The start timing of Auto Check may be, for example, A. a timing at which the printer 10 is turned on, B. a timing at which 24 hours or longer elapses since the firmware server 40 is accessed last time and no new firmware is registered in a state in which the printer 10 is kept on, and the controller 11 is not in the power-saving state, and C. a timing at which 30 days or longer elapses since the firmware server 40 is accessed last time and the new firmware is registered in the state in which the printer 10 is kept on, but the user rejects the firmware update, and the controller 11 is not in the power-saving state. The controller 11 may not execute the Firmware Update process illustrated in FIG. 10 in the power-saving state. In addition, the controller 11 may not execute the process in accordance with the firmware 13A in the power-saving state. In either case, S5 does not become YES.

When it is determined in S5 that it is the start timing of Auto Check (S5: YES), the controller 11 executes the Auto Check process (S6) and then returns the process to S1. On the other hand, when it is determined in S5 that it is not the start timing of Auto Check (S5: NO), the controller 11 returns the process to S1. When it is determined in S1 that the setting value of the Update Method indicates OFF (S1: OFF), the controller 11 returns the process to S1.

FIG. 17 illustrates a detailed procedure of the Auto Check process. In FIG. 17, the same processes as the update execution process of FIG. 16 are denoted by the same reference numerals, and the description thereof will be appropriately omitted. In FIG. 17, when it is possible to connect to the firmware server 40 (S100: YES), the controller 11 inquires of the firmware server 40 whether the firmware 13A needs to be updated (S101). Then, when there is a reply indicating that the firmware 13A needs to be updated from the firmware server 40 (S102: YES), the controller 11 causes the information bar of the standby screen to indicate that the new version of firmware is available (S103). FIG. 20B illustrates a standby screen 1023. The information bar 102A of the standby screen 1023 indicates that the new version of firmware is available. That is, the user IF 12 before the process proceeds to S103 displays the standby screen 102 illustrated in FIG. 20A, and when the process proceeds to S103, the standby screen 102 is transitioned to the standby screen 1023.

Next, the controller 11 waits until the information bar 102A of the standby screen 1023 is operated (S104: NO), and causes the user IF 12 to display a Firmware Update execution selection screen when the information bar 102A is operated (S104: YES) (S105). FIG. 20C illustrates a Firmware Update execution selection screen 190. When a Yes icon 190A included in the Firmware Update execution selection screen 190 is operated (S106: YES), the controller 11 causes the user IF 12 to display an attention calling display screen 200 as illustrated in FIG. 20D (S107).

Then, when an OK icon 200A included in the attention calling display screen 200 is operated (S108: YES), the controller 11 downloads latest firmware from the firmware server 40 (S74), updates the firmware 13A with the latest firmware (S75), re-activates the printer 10 (S76), and ends the Auto Check process without causing the information bar 102A of the standby screen 102 to indicate that the firmware is updated. FIG. 20E illustrates the downloading screen 106 displayed on the user IF 12 during the process in S102, and FIG. 20F illustrates the updating screen 107 displayed on the user IF 12 during the process in S75.

As described above, according to the printer 10 of the present embodiment, it is possible to set the default time slot without receiving the input for designating the time slot via the user IF 12 at the time of the initial installation of the printer 10, and the user IF 12 displays the attention calling display screen 101 indicating that the firmware server 40 is accessed at the time during the default time slot, and thus it is possible to further improve the usability for the user.

The attention calling display screen 101 indicates that the firmware is attempted to be updated at the time during the default time slot and displays a method of designating a time slot by the operation via the user IF 12, and thus the user can know the time slot during which the firmware is updated and can know that the time slot can be changed by using the method of designating a time slot.

In addition, the default time slot registered in the memory 13 can be changed using the Time Slot setting screen 170, and the firmware server 40 is accessed at the time during the changed time slot registered in the memory 13, after the change. Accordingly, it is possible to access the firmware server 40 at a time during a time slot desired by the user.

The attention calling display screen 101 indicates that, if the printer 10 loses power during an update of the firmware and the update of the firmware fails, the printer 10 is connected to the PC 30 with the USB cable to finish the update of the firmware, and thus the user can know that the update of the firmware can also be finished by using another method when the update of the firmware fails.

When the default time slot set at the time of the initial installation of the printer 10 is registered in the memory 13, it is notified via the user IF 12, for example, by the information bar 102A that the firmware server 40 is accessed at the time during the default time slot at a timing for causing the user IF 12 to display the standby screen 1021, and thus the situation in which the firmware 13A is unexpectedly updated without the user's knowledge is avoided.

In addition, in response to the current time becoming the pre-notification time, the user IF 12 displays the pre-notification screen 104 to indicate that the firmware server 40 is accessed at the time during the time slot registered in the memory 13, and thus the situation in which the firmware 13A is unexpectedly updated without the user's knowledge is avoided.

Further, in response to the current time becoming the immediate pre-notification time, the user IF 12 displays the immediate pre-notification screen 105 to indicate that the firmware server 40 is accessed soon, and thus the situation in which the firmware 13A is unexpectedly updated without the user's knowledge is further avoided.

In addition, it is notified via the pre-notification screen 104 displayed on the user IF 12 that in response to receiving an operation on the Cancel Update icon 104B included in the pre-notification screen 104 after causing the user IF 12 to display the pre-notification screen 104, the firmware server 40 is not accessed at the access time, and in response to a predetermined time before the next access time, the firmware server 40 is accessed at the time during the time slot registered in the memory 13. Accordingly, it is possible to access the firmware server 40 at a timing convenient for the user.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

As described above with reference to FIGS. 15A and 15B, the printer 10 according to the present embodiment finishes the update of the firmware within the “Auto Update execution time slot” by setting the access time in the “Auto Update startable time slot”. Here, the firmware update may be allowed to be finished at a time slightly after the Auto Update execution time slot. Specifically, the controller 11 may determine the access time not only from the time included in the “Auto Update startable time slot” but also from the time included in the “Auto Update execution time slot”. In this case, depending on the firmware automatic update start time, the automatic update of the firmware cannot be finished within the Auto Update execution time slot, but this does not depart from the gist of the present application. That is, in Modification 1, even if the printer of Modification 1 and other printers access the firmware server 40 on overlapping dates and in overlapping time slots, the access times for the printer of Modification 1 and the other printers to access the firmware server 40 are distributed, and thus it is possible to obtain an effect that it is possible to reduce the concentration of the load on the firmware server 40. There is a slight possibility that the firmware update cannot be finished within a time slot convenient for the user, but the firmware can be updated on a date and time slot convenient for the user.

### Modification 2

In the printer 10 of the present embodiment, any one of the Auto Update method, the Auto Check method, and the manual method can be set as the firmware update method, but a specific method of updating firmware using the manual method has not been described. As the manual method, specifically, when an instruction to display an input screen (an example of a first input) is received via the user IF 12, the controller 11 may cause the user IF 12 to display an input screen for receiving an input of an instruction to access the firmware server 40, and when an input of an instruction to access the firmware server 40 (an example of a second input) is received via the input screen, the controller 11 may access the firmware server 40. According to the printer of Modification 2, the user can cause the printer to attempt to update the firmware on a date and time slot convenient for the user by enabling the Auto Update method, can cause the user IF 12 to display the input screen and attempt to update the firmware at a time convenient for the user by enabling the manual method, and can attempt to update the firmware every time the printer is activated by enabling the Auto Check method.

### Modification 3

In the printer 10 of the present embodiment, the days of the week are set as the date for accessing the firmware server 40, but the present disclosure is not limited thereto, and date-related information, for example, the date, how many days passed since the previous access date, which day of the month, and every month may be set. According to the printer of Modification 3, when the Auto Update method is enabled, even if the user sets a date on which the printer of Modification 3 is not used, the user does not request an input for instructing the firmware update to the user IF 12 before the firmware is updated, and thus the update of the firmware is not hindered and the display indicating that the firmware has been updated is performed, so that the user can know that the firmware has been updated when the printer of Modification 3 is used after the update of the firmware.

### Modification 4

In the printer 10 of the present embodiment, the firmware update method or the date and time slot for accessing the firmware server 40 is set via the user IF 12, but the present disclosure is not limited thereto, and the firmware update method or the date and time slot may be set using the PC 30. Specifically, the firmware 13A includes a program that functions as a Web server for an Embedded Web Server (EWS) by being executed with the controller 11, and when an administrator of the printer 10 activates a browser on the PC 30 and inputs a predetermined URL for the EWS in a URL input field of the browser, a browser screen for setting the printer 10 is displayed on a display (not illustrated) of the PC 30. The administrator may perform a predetermined operation on the browser screen for setting the printer 10 and advance a setting change process, thereby setting the firmware update method or the date and time slot for accessing the firmware server 40.

The present disclosure is not limited to the above-described embodiment, and various modifications can be made without departing from the gist of the present disclosure.
(1) In the above-described embodiment, the printer 10 has been described as an example of the printing apparatus, and the printing apparatus may be a multifunction peripheral including an FAXIF.
(2) In the above-described embodiment, the PC 30 has been described as an example of the external device, and a mobile terminal such as a smartphone may be used as the external device.
(3) In the above-described embodiment, the SNTP server 50 is a component of the image forming system 1, and the SNTP server 50 may be excluded from the components of the image forming system 1.

The present application may provide a printing apparatus described in the following Appendices A1 to A31 and Appendices B1 to B15.

### APPENDIX A1

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time; and
   access the firmware server at the determined access time every time a date for accessing the firmware server arrives.

### APPENDIX A2

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to an end time of the designated time slot; and
   access the firmware server at the determined access time every time a date for accessing the firmware server arrives.

### APPENDIX A3

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update; and
   receive an input for designating a time slot via the user interface,
wherein every time a date for accessing the firmware server arrives, the controller is configured to:
   access the firmware server in a case in which the printing apparatus is not in a state in which the firmware is not allowed to be updated at a time during the designated time slot; and
   not access the firmware server in a case in which the printing apparatus is in the state in which the firmware is not allowed to be updated at a time during the designated time slot, and access the firmware server in a case in which the printing apparatus is not in the state in which the firmware is not allowed to be updated on a next date for accessing the firmware server.

### APPENDIX A4

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update; and
   receive an input related to a time to access the firmware server via the user interface,
wherein every time a date for accessing the firmware server arrives, the controller is configured to:
   access the firmware server, download firmware for update from the firmware server, and update the firmware stored in the memory with the downloaded firmware for update, in a case in which the printing apparatus is not in a state in which the firmware is not allowed to be updated at a time based on the received input; and
   access the firmware server and download firmware for update from the firmware server, in a case in which the printing apparatus is in the state in which the firmware is not allowed to be updated at the time based on the received input, and update the firmware stored in the memory with the downloaded firmware for update after the printing apparatus is no longer in the state in which the firmware is not allowed to be updated.

### APPENDIX A5

The printing apparatus according to any one of Appendices A1 to A4,
wherein the controller is configured to receive an input for designating a day of a week via the user interface, and
wherein the date for accessing the firmware server is a date corresponding to the designated day of the week.

### APPENDIX A6

The printing apparatus according to any one of Appendices A1 to A3,
wherein the controller is configured to receive an input for designating the time slot from an external device connected via the network interface.

### APPENDIX A7

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   receive an input for enabling a first method via the user interface; and
   receive an input for enabling a second method via the user interface,
wherein the second method is not allowed to be enabled in a case in which the first method is enabled, and the first method is not allowed to be enabled in a case in which the second method is enabled,
wherein in a case in which the first method is enabled, the controller is configured to access the firmware server at a time during the designated time slot every time a date for accessing the firmware server arrives, and
wherein in a case in which the second method is enabled, the controller is configured to access the firmware server every time the printing apparatus is activated.

### APPENDIX A8

The printing apparatus according to Appendix A7,
wherein in a case in which the first method is enabled, the controller is configured to update the firmware stored in the memory with the firmware downloaded from the accessed firmware server without requesting an input of an instruction to update the firmware via the user interface before the firmware stored in the memory is updated, and after the update, cause the user interface to indicate that the firmware is updated, after the update, and
wherein in a case in which the second method is enabled, the controller is configured to request an input of an instruction to update the firmware via the user interface before the firmware stored in the memory is updated, update the firmware stored in the memory with the firmware downloaded from the accessed firmware server in a case in which there is the requested input, and after the update, not cause the user interface to indicate that the firmware is updated.

### APPENDIX A9

The printing apparatus according to Appendix A8,
wherein the controller is configured to receive, as the input for designating the time slot, an input for designating a night time slot, an input for designating a day time slot, an input for designating an early morning time slot, and an input for designating an evening time slot.

### APPENDIX A10

The printing apparatus according to Appendix A8,
wherein the controller is configured to receive an input for designating a day of a week via the user interface, and
wherein the date for accessing the firmware server is a date corresponding to the designated day of the week.

### APPENDIX All

The printing apparatus according to Appendix A8,
wherein the controller is configured to:
   receive an input related to a date for accessing the firmware server via the user interface; and
   access the firmware server at a time during the designated time slot every time the date for accessing the firmware server based on the received input arrives.

### APPENDIX A12

The printing apparatus according to Appendix A8,
wherein the controller is configured to:
   cause the user interface to display a standby screen including a plurality of icons including a copy icon and a scan icon; and
   execute copying in response to the copy icon being operated, and execute scanning in response to the scan icon being operated,
wherein in a case in which the first method is enabled, after the firmware is updated, the controller is configured to cause the user interface to receive an operation on the plurality of icons and to display the standby screen indicating that the firmware is updated, and
wherein in a case in which the second method is enabled, before the firmware is updated, the controller is configured to cause the user interface to receive an operation on the plurality of icons and to display the standby screen for requesting an input of an instruction to update the firmware.

### APPENDIX A13

The printing apparatus according to Appendix A8,
wherein in a case in which the first method is enabled, the controller is configured to cause the user interface to display a warning that the firmware is automatically updated, and
wherein in a case in which the second method is enabled, the controller is configured not to cause the user interface to display the warning that the firmware is automatically updated.

### APPENDIX A14

The printing apparatus according to Appendix A8,
wherein in a case in which the first method is enabled, even in a case in which a time during the designated time slot on the date for accessing the firmware server arrives but the firmware is not downloaded from the firmware server, the controller is configured to access the firmware server at a time during the designated time slot on a next date for accessing the firmware server, and
wherein in a case in which the second method is enabled, even in a case in which the printing apparatus is activated but the firmware is not downloaded from the firmware server, the controller is configured to access the firmware server after a predetermined time elapses.

### APPENDIX A15

The printing apparatus according to Appendix A8,
wherein in a case in which specific print data is stored in the memory, the controller is configured to:
   not update the firmware in a case in which the first method is enabled; and
   update the firmware in a case in which the second method is enabled.

### APPENDIX A16

The printing apparatus according to Appendix A7, further including:
a clock,
wherein the controller is configured to:
   access the firmware server at the time during the designated time slot every time the date for accessing the firmware server arrives in a case in which the clock is set to be enabled and the first method is enabled; and
   access the firmware server every time the printing apparatus is activated regardless of whether the clock is set to be enabled in a case in which the second method is enabled.

### APPENDIX A17

The printing apparatus according to Appendix A7,
wherein at a time of initial installation of the printing apparatus, the controller is configured to cause the user interface to display a screen allowing an input for enabling the first method to be received and not allowing an input for enabling the second method to be received before causing the user interface to display a standby screen of the printing apparatus.

### APPENDIX A18

The printing apparatus according to Appendix A17,
wherein in a case in which the first method is enabled at a time of initial installation of the printing apparatus, the controller is configured to set a predetermined time slot without receiving the input for designating the time slot via the user interface in a case in which the first method is enabled at the time of initial installation of the printing apparatus,
wherein after the initial installation of the printing apparatus, the controller is configured to:
   cause the user interface to display a standby screen including a plurality of icons including a copy icon and a scan icon;
   execute copying in response to the copy icon being operated, and execute scanning in response to the scan icon being operated; and
   cause the user interface to display a setting screen for receiving the input for designating the time slot by receiving an operation via the user interface after the standby screen is displayed, and
wherein in a case in which the first method is enabled after the initial installation of the printing apparatus, every time the date for accessing the firmware server arrives, the controller is configured to:
   access the firmware server at a time during the predetermined time slot set at the time of the initial installation in a case in which the input for designating the time slot is not received; and
   access the firmware server at the time during the designated time slot in a case in which the input for designating the time slot is received.

### APPENDIX A19

The printing apparatus according to Appendix A17,
wherein after the initial installation of the printing apparatus, the controller is configured to:
   cause the user interface to display a standby screen including a plurality of icons including a copy icon and a scan icon;
   execute copying in response to the copy icon being operated, and execute scanning in response to the scan icon being operated; and
   cause the user interface to display a setting screen for receiving an input for enabling the second method by receiving an operation via the user interface after the standby screen is displayed.

### APPENDIX A20

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   access the firmware server at a time during the designated time slot every time a date for accessing the firmware server arrives;
   access the firmware server every time the printing apparatus is activated; and
   cause the user interface to display an input screen for receiving an input of an instruction to access the firmware server in response to receiving a first input via the user interface, and access the firmware server in response to receiving a second input via the input screen.

### APPENDIX A21

The printing apparatus according to Appendix A20,
wherein the controller is configured to:
   receive an input for enabling a first method via the user interface; and
   receive an input for enabling a second method via the user interface,
wherein in a case in which the first method is enabled, the controller is configured to access the firmware server at a time during the designated time slot every time the date for accessing the firmware server arrives,
wherein in a case in which the second method is enabled, the controller is configured to access the firmware server every time the printing apparatus is activated, and
wherein regardless of whether the first method is enabled or the second method is enabled, the controller is configured to cause the user interface to display the input screen for receiving the input of an instruction to access the firmware server in response to receiving the first input via the user interface, and access the firmware server in response to receiving the second input via the input screen.

### APPENDIX A22

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input related to a time to access the firmware server via the user interface;
   receive an input for enabling a first method via the user interface; and
   receive an input for enabling a second method via the user interface,
wherein the second method is not allowed to be enabled in a case in which the first method is enabled, and disable the first method is not allowed to be enabled in a case in which the second method is enabled,
wherein in a case in which the first method is enabled, the controller is configured to access the firmware server at a time based on the received input every time a date for accessing the firmware server arrives, and
wherein in a case in which the second method is enabled, the controller is configured to access the firmware server every time the printing apparatus is activated.

### APPENDIX A23

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input related to a time to access the firmware server via the user interface;
   access the firmware server at a time based on the received input every time a date for accessing the firmware server arrives;
   access the firmware server every time the printing apparatus is activated; and
   cause the user interface to display an input screen for receiving an input of an instruction to access the firmware server in response to receiving a first input via the user interface, and access the firmware server in response to receiving a second input via the input screen.

### APPENDIX A24

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive, via the user interface, an input for designating a night time slot, an input for designating a day time slot, an input for designating an early morning time slot, and an input for designating an evening time slot;
   access the firmware server at a time during the designated time slot every time a date for accessing the firmware server arrives; and
   update the firmware stored in the memory with the firmware downloaded from the accessed firmware server without requesting an input of an instruction to update the firmware via the user interface before the firmware stored in the memory is updated, and after the update, cause the user interface to indicate that the firmware is updated.

### APPENDIX A25

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a day of a week via the user interface;
   receive an input for designating a time slot via the user interface;
   access the firmware server at a time during the designated time slot every time a date corresponding to the designated day of the week arrives; and
   update the firmware stored in the memory with the firmware downloaded from the accessed firmware server without requesting an input of an instruction to update the firmware via the user interface before the firmware stored in the memory is updated, and after the update, cause the user interface to indicate that the firmware is updated.

### APPENDIX A26

A printing apparatus including:
a memory;
a network interface;
a user interface; and
a controller, wherein
the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input related to a date for accessing the firmware server via the user interface;
   receive an input for designating a time slot via the user interface;
   access the firmware server at a time during the designated time slot every time the date for accessing the firmware server based on the received input arrives; and
   update the firmware stored in the memory with the firmware downloaded from the accessed firmware server without requesting an input of an instruction to update the firmware via the user interface before the firmware stored in the memory is updated, and after the update, cause the user interface to indicate that the firmware is updated.

### APPENDIX A27

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   access the firmware server at a time during the designated time slot every time a date for accessing the firmware server arrives; and
   set a predetermined time slot without receiving the input for designating the time slot via the user interface at a time of initial installation of the printing apparatus,
wherein after the initial installation of the printing apparatus, the controller is configured to:
   cause the user interface to display a standby screen including a plurality of icons including a copy icon and a scan icon;
   execute copying in response to the copy icon being operated, and execute scanning in response to the scan icon being operated; and
   cause the user interface to display a setting screen for receiving the input for designating the time slot by receiving an operation via the user interface after the standby screen is displayed, and
wherein after the initial installation of the printing apparatus, every time the date for accessing the firmware server arrives, the controller is configured to:
   access the firmware server at a time during the predetermined time slot set at the time of the initial installation in a case in which the input for designating the time slot is not received; and
   access the firmware server at the time during the designated time slot in a case in which the input for designating the time slot is received.

### APPENDIX A28

The printing apparatus according to Appendix A27,
wherein the controller is configured to update the firmware stored in the memory with the firmware downloaded from the accessed firmware server without requesting an input of an instruction to update the firmware via the user interface before the firmware stored in the memory is updated, and after the update, cause the user interface to indicate that the firmware is updated.

### APPENDIX A29

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   receive an input for designating a day of a week via the user interface;
   register the designated time slot and the designated day of the week in the memory;
   access the firmware server at a time during the time slot registered in the memory every time the day of the week registered in the memory arrives;
   cause the user interface to display a standby screen including a plurality of icons including a copy icon and a scan icon; and
   execute copying in response to the copy icon being operated, and execute scanning in response to the scan icon being operated,
wherein in response to receiving a predetermined operation via the user interface after the standby screen is displayed, the controller is configured to:
   cause the user interface to display a screen including a selection option indicating the day of the week registered in the memory and a selection option indicating the time slot registered in the memory;
   change the day of the week registered in the memory in response to receiving, via the user interface, an operation including a selection of the selection option indicating the day of the week registered in the memory; and
   change the time slot registered in the memory in response to receiving, via the user interface, an operation including a selection of the selection option indicating the time slot registered in the memory.

### APPENDIX A30

The printing apparatus according to Appendix A29,
wherein the controller is configured to register a valid method in the memory,
wherein in a case in which a first method is registered in the memory as being valid, the controller is configured to access the firmware server at the time during the time slot registered in the memory every time the day of the week registered in the memory arrives,
wherein in a case in which the second method is registered in the memory as being valid, the controller is configured to access the firmware server,
wherein in response to receiving the predetermined operation via the user interface after the standby screen is displayed, the controller is configured to:
   cause the user interface to display a screen including a selection option indicating the valid method registered in the memory, a selection option indicating the day of the week registered in the memory, and a selection option indicating the time slot registered in the memory; and
   change the valid method registered in the memory in response to receiving, via the user interface, an operation including a selection of the selection option indicating the valid method registered in the memory.

### APPENDIX A31

The printing apparatus according to Appendix A30,
wherein in response to receiving the predetermined operation via the user interface after the standby screen is displayed,
   in a case in which the first method is registered in the memory as being valid, the controller is configured to:
      cause the user interface to display a screen including a selection option indicating the valid method registered in the memory, a valid selection option indicating the day of the week registered in the memory, and a valid selection option indicating the time slot registered in the memory;
      change the valid method registered in the memory in response to receiving, via the user interface, the operation including the selection of the selection option indicating the valid method registered in the memory;
      change the day of the week registered in the memory in response to receiving, via the user interface, an operation including a selection of the valid selection option indicating the day of the week registered in the memory; and
      change the time slot registered in the memory in response to receiving, via the user interface, an operation including a selection of the valid selection option indicating the time slot registered in the memory, and
   in a case in which the second method is registered in the memory as being valid, the controller is configured to:
      cause the user interface to display a screen that includes the selection option indicating the valid method registered in the memory and that does not include the valid selection option indicating the day of the week registered in the memory and the valid selection option indicating the time slot registered in the memory; and
      change the valid method registered in the memory in response to receiving, via the user interface, the operation including the selection of the selection option indicating the valid method registered in the memory.

### APPENDIX B1

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time;
   access the firmware server at the determined access time every time a date for accessing the firmware server arrives;
   set a predetermined time slot without receiving the input for designating the time slot via the user interface at the time of initial installation of the printing apparatus; and
   cause the user interface to display a notification screen indicating that the firmware server is to be accessed at a time during the predetermined time slot.

### APPENDIX B2

The printing apparatus according to Appendix B1,
wherein the controller is configured to cause the user interface to display, as the notification screen, a screen indicating that the firmware is to be attempted to be updated at any time during the predetermined time slot and indicating a method of designating a time slot by an operation via the user interface.

### APPENDIX B3

The printing apparatus according to Appendix B2,
wherein the controller is configured to:
   register, in the memory, the predetermined time slot set at a time of the initial installation of the printing apparatus;
   cause, after causing the user interface to display, the user interface to display a standby screen including a plurality of icons including a copy icon and a scan icon, after causing the user interface to display, as the notification screen, the screen indicating the firmware is to be attempted to be updated at any time during the predetermined time slot and indicating the method of designating the time slot by the operation via the user interface;
   execute copying in response to the copy icon being operated, and execute scanning in response to the scan icon being operated;
   cause the user interface to display a setting screen for receiving an input for designating the time slot in response to receiving an operation via the user interface by using the method indicated in the notification screen after displaying the standby screen; and
   change the predetermined time slot registered in the memory to the time slot designated by the input via the setting screen, and after the change, access the firmware server at a time during the changed time slot registered in the memory.

### APPENDIX B4

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time;
   access the firmware server at the determined access time every time a date for accessing the firmware server arrives;
   set a predetermined time slot without receiving the input for designating the time slot via the user interface at a time of initial installation of the printing apparatus; and
   cause the user interface to display a notification screen indicating that the firmware is to be attempted to updated at any time during the predetermined time slot and indicating a method of designating a time slot by an operation via the user interface.

### APPENDIX B5

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time;
   access the firmware server at the determined access time every time a date for accessing the firmware server arrives;
   set a predetermined time slot without receiving the input for designating the time slot via the user interface at the time of initial installation of the printing apparatus; and
   cause the user interface to display a notification screen indicating that the firmware is to be attempted to be updated at any time during the predetermined time slot, and that in a case in which the printing apparatus loses power during an update of the firmware and the update of the firmware fails, the printing apparatus is connected to an external computer with a cable to finish the update of the firmware.

### APPENDIX B6

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time;
   access the firmware server at the determined access time every time a date for accessing the firmware server arrives;
   set a predetermined time slot without receiving an input for designating the time slot via the user interface at a time of initial installation of the printing apparatus;
   register a time slot including the predetermined time slot in the memory;
   cause the user interface to display a standby screen including a plurality of icons including a copy icon and a scan icon;
   execute copying in response to the copy icon being operated, and execute scanning in response to the scan icon being operated; and
   output a notification, via the user interface, at a timing for causing the user interface to display the standby screen in a case in which the predetermined time slot set at the time of the initial installation of the printing apparatus is registered in the memory, the notification indicating that the firmware server is to be accessed at a time during the predetermined time slot.

### APPENDIX B7

The printing apparatus according to Appendix B6,
wherein the controller is configured to:
   cause the user interface to display a screen as a notification screen at the timing for causing the user interface to display the standby screen in a case in which the predetermined time slot set at the time of the initial installation of the printing device is registered in the memory, the screen including a notification that the firmware server is to be accessed at the time during the predetermined time slot and a selection option corresponding to a setting screen for receiving an input for designating the time slot;
   cause the user interface to display the setting screen for receiving the input for designating the time slot in response to receiving an operation on the selection option included in the notification screen after causing the user interface to display the notification screen; and
   change the time slot registered in the memory to the time slot designated by the input via the setting screen, and after the change, access the firmware server at a time during the changed time slot registered in the memory.

### APPENDIX B8

The printing apparatus according to Appendix B7,
wherein the controller is configured to:
   cause an information display region in the standby screen to display a character string at the timing for causing the user interface to display the standby screen in a case in which the predetermined time slot set at the time of the initial installation of the printing device is registered in the memory, the character string indicating that the firmware server is to be accessed at the time during the predetermined time slot; and
   cause the user interface to display the notification screen in response to receiving an operation on the information display region after causing the information display region to display the character string.

### APPENDIX B9

A printing apparatus including:
a memory;
a network interface;
a user interface; and
a controller,
wherein the controller is configured to:
   operate the printing apparatus by executing firmware stored in the memory;
   access a firmware server on an Internet via the network interface, download firmware for update from the firmware server, and update the firmware stored in the memory with the downloaded firmware for update;
   receive an input for designating a time slot via the user interface;
   determine an access time to the firmware server from a time slot from a start time of the designated time slot to a time before an end time of the designated time slot by a predetermined time;
   access the firmware server at the determined access time every time a date for accessing the firmware server arrives;
   set a predetermined time slot without receiving the input for designating the time slot via the user interface at the time of initial installation of the printing apparatus;
   register a time slot in the memory; and
   output a notification via the user interface in response to arrival of a time before the access time to the firmware server by a predetermined time, the notification indicating that the firmware server is to be accessed at a time during the time slot registered in the memory.

### APPENDIX B10

The printing apparatus according to Appendix B9,
wherein the controller is configured to:
   output a notification via the user interface in response to arrival of a time before the access time to the firmware server by a first predetermined time, the notification indicating that the firmware server is to be accessed at the time during the time slot registered in the memory; and
   output a notification via the user interface in response to arrival of a time before the access time to the firmware server by a second predetermined time, the notification indicating that the firmware server is about to be accessed, and
wherein the second predetermined time is shorter than the first predetermined time.

### APPENDIX B11

The printing apparatus according to Appendix B9,
wherein the controller is configured to:
   cause the user interface to display a notification screen in response to arrival of a time before the access time to the firmware server by the predetermined time, the notification screen including a notification indicating that the firmware server is to be accessed at the time during the time slot registered in the memory and a selection option corresponding to cancellation of the access to the firmware server; and
   not access the firmware server at the access time in response to receiving an operation on the selection option included in the notification screen after causing the user interface to display the notification screen, and output a notification via the user interface in response to arrival of a time before a next access time by the predetermined time, the notification indicating that the firmware server is to be accessed at the time during the time slot registered in the memory.

### APPENDIX B12

The printing apparatus according to Appendix B11,
wherein the notification screen further includes a selection option corresponding to approval of the notification that the firmware server is to be accessed at the time during the time slot registered in the memory, and
wherein the controller is configured to:
   cause, after causing the user interface to display the notification screen, the user interface to display a standby screen including a plurality of icons including a copy icon and a scan icon;
   execute copying in response to the copy icon being operated, and execute scanning in response to the scan icon being operated;
   cause, after causing the user interface to display the notification screen, the user interface to display the standby screen in response to receiving an operation on any one of the selection option corresponding to the cancellation and the selection option corresponding to the approval of the notification that are included in the notification screen; and
   access, after causing the user interface to display the notification screen, the firmware server at the time during the time slot registered in the memory without causing the user interface to display the standby screen in a case in which no operation on any one of the selection option corresponding to the cancellation and the selection option corresponding to the approval of the notification that are included in the notification screen is received.

### APPENDIX B13

The printing apparatus according to Appendix B9,
wherein the controller is configured to:
   access the firmware server at a timing different from the access time to the firmware server, and confirm whether there is firmware to be updated; and
   not perform the notification that the firmware server is accessed at the time during the time slot registered in the memory even arrival of the time before the access time to the firmware server by the predetermined time in a case in which there is no firmware to be updated.

### APPENDIX B14

The printing apparatus according to Appendix B13,
wherein the timing different from the access time to the firmware server is within a predetermined time after the printing apparatus is turned on.

### APPENDIX B15

The printing apparatus according to Appendix B10,
wherein in a case in which the printing apparatus is turn on after a time before the access time to the firmware server by a third predetermined time which is shorter than the first predetermined time and longer than the second predetermined time, the controller is configured not to access the firmware server, and then output a notification via the user interface in response to arrival of a time before a next access time by the first predetermined time, the notification indicating that the firmware server is to be accessed at the time during the time slot registered in the memory.

What is claimed is:

1. A printing apparatus comprising:
a memory;
a network interface;
a user interface; and
a controller,
wherein the controller is configured to:
operate the printing apparatus by executing firmware stored in the memory;
access a firmware server on an Internet via the network interface, download firmware for update from the firmware server, and update the firmware stored in the memory with the downloaded firmware for update;
receive an input for designating a time slot via the user interface;
determine an access time to the firmware server from a time slot, the time slot being a first time slot or a second time slot, the first time slot being from a start time of the designated time slot to a time before an end time of the designated time slot by a predetermined time, the second time slot being from the start time of the designated time slot to the end time of the designated time slot; and
access the firmware server at the determined access time every time a date for accessing the firmware server arrives.

2. The printing apparatus according to claim 1,
wherein every time the date for accessing the firmware server arrives, the controller is configured to:
access the firmware server in a case in which the printing apparatus is not in a state in which the firmware is not allowed to be updated at a time during the designated time slot; and
not access the firmware server in a case in which the printing apparatus is in the state in which the firmware is not allowed to be updated at a time during the designated time slot, and access the firmware server in a case in which the printing apparatus is not in the state in which the firmware is not allowed to be updated on a next date for accessing the firmware server.

3. The printing apparatus according to claim 1,
wherein every time the date for accessing the firmware server arrives, the controller is configured to:
access the firmware server, download firmware for update from the firmware server, and update the firmware stored in the memory with the downloaded firmware for update, in a case in which the printing apparatus is not in a state in which the firmware is not allowed to be updated at a time based on the received input; and
access the firmware server and download firmware for update from the firmware server, in a case in which the printing apparatus is in the state in which the firmware is not allowed to be updated at the time based on the received input, and update the firmware stored in the memory with the downloaded firmware for update after the printing apparatus is no longer in the state in which the firmware is not allowed to be updated.

4. The printing apparatus according to claim 1,
wherein the controller is configured to receive an input for designating a day of a week via the user interface, and
wherein the date for accessing the firmware server is a date corresponding to the designated day of the week.

5. The printing apparatus according to claim 1,
wherein the controller is configured to receive an input for designating the time slot from an external device connected via the network interface.

6. The printing apparatus according to claim 1,
wherein the controller is configured to:
access the firmware server at a time during the designated time slot every time the date for accessing the firmware server arrives;
access the firmware server every time the printing apparatus is activated; and
cause the user interface to display an input screen for receiving an input of an instruction to access the firmware server in response to receiving a first input via the user interface, and access the firmware server in response to receiving a second input via the input screen.

7. The printing apparatus according to claim 1,
wherein the controller is configured to:
set a predetermined time slot without receiving the input for designating the time slot via the user interface at the time of initial installation of the printing apparatus; and
cause the user interface to display a notification screen indicating that the firmware server is to be accessed at a time during the predetermined time slot.

8. The printing apparatus according to claim 7,
wherein the controller is configured to cause the user interface to display, as the notification screen, a screen indicating that the firmware is to be attempted to be updated at any time during the predetermined time slot and indicating a method of designating a time slot by an operation via the user interface.

9. The printing apparatus according to claim 7,
wherein the controller is configured to:
register, in the memory, the predetermined time slot set at a time of the initial installation of the printing apparatus;
cause, after causing the user interface to display, the user interface to display a standby screen comprising a plurality of icons including a copy icon and a scan icon, after causing the user interface to display, as the notification screen, the screen indicating the firmware is to be attempted to be updated at any time during the predetermined time slot and indicating the method of designating the time slot by the operation via the user interface;
execute copying in response to the copy icon being operated, and execute scanning in response to the scan icon being operated;
cause the user interface to display a setting screen for receiving an input for designating the time slot in response to receiving an operation via the user interface by using the method indicated in the notification screen after displaying the standby screen; and
change the predetermined time slot registered in the memory to the time slot designated by the input via the setting screen, and after the change, access the firmware server at a time during the changed time slot registered in the memory.

10. The printing apparatus according to claim 1,
wherein the controller is configured to:
set a predetermined time slot without receiving the input for designating the time slot via the user interface at a time of initial installation of the printing apparatus; and
cause the user interface to display a notification screen indicating that the firmware is to be attempted to updated at any time during the predetermined time slot and indicating a method of designating a time slot by an operation via the user interface.

11. The printing apparatus according to claim 1,
wherein the controller is configured to:
set a predetermined time slot without receiving the input for designating the time slot via the user interface at the time of initial installation of the printing apparatus; and
cause the user interface to display a notification screen indicating that the firmware is to be attempted to be updated at any time during the predetermined time slot, and that in a case in which the printing apparatus loses power during an update of the firmware and the update of the firmware fails, the printing apparatus is connected to an external computer with a cable to finish the update of the firmware.

12. The printing apparatus according to claim 1,
wherein the controller is configured to:
cause the user interface to display a standby screen comprising a plurality of icons including a copy icon and a scan icon;
execute copying in response to the copy icon being operated, and execute scanning in response to the scan icon being operated; and
output a notification, via the user interface, at a timing for causing the user interface to display the standby screen in a case in which the predetermined time slot set at the time of the initial installation of the printing apparatus is registered in the memory, the notification indicating that the firmware server is to be accessed at a time during the predetermined time slot.

13. The printing apparatus according to claim 12,
wherein the controller is configured to:
cause the user interface to display a screen as a notification screen at the timing for causing the user interface to display the standby screen in a case in which the predetermined time slot set at the time of the initial installation of the printing device is registered in the memory, the screen including a notification that the firmware server is to be accessed at the time during the predetermined time slot and a selection option corresponding to a setting screen for receiving an input for designating the time slot;
cause the user interface to display the setting screen for receiving the input for designating the time slot in response to receiving an operation on the selection option included in the notification screen after causing the user interface to display the notification screen; and
change the time slot registered in the memory to the time slot designated by the input via the setting screen, and after the change, access the firmware server at a time during the changed time slot registered in the memory.

14. The printing apparatus according to claim 13,
wherein the controller is configured to:
cause an information display region in the standby screen to display a character string at the timing for causing the user interface to display the standby screen in a case in which the predetermined time slot set at the time of the initial installation of the printing device is registered in the memory, the character string indicating that the firmware server is to be accessed at the time during the predetermined time slot; and
cause the user interface to display the notification screen in response to receiving an operation on the information display region after causing the information display region to display the character string.

15. The printing apparatus according to claim 1,
wherein the controller is configured to:
output a notification via the user interface in response to arrival of a time before the access time to the firmware server by a predetermined time, the notification indicating that the firmware server is to be accessed at a time during the time slot registered in the memory.

16. The printing apparatus according to claim 15,
wherein the controller is configured to:
output a notification via the user interface in response to arrival of a time before the access time to the firmware server by a first predetermined time, the notification indicating that the firmware server is to be accessed at the time during the time slot registered in the memory; and
output a notification via the user interface in response to arrival of a time before the access time to the firmware server by a second predetermined time, the notification indicating that the firmware server is about to be accessed, and
wherein the second predetermined time is shorter than the first predetermined time.

17. The printing apparatus according to claim 15,
wherein the controller is configured to:
cause the user interface to display a notification screen in response to arrival of a time before the access time to the firmware server by the predetermined time, the notification screen including a notification indicating that the firmware server is to be accessed at the time during the time slot registered in the memory and a selection option corresponding to cancellation of the access to the firmware server; and
not access the firmware server at the access time in response to receiving an operation on the selection option included in the notification screen after causing the user interface to display the notification screen, and output a notification via the user interface in response to arrival of a time before a next access time by the predetermined time, the notification indicating that the firmware server is to be accessed at the time during the time slot registered in the memory.

18. The printing apparatus according to claim 17,
wherein the notification screen further includes a selection option corresponding to approval of the notification that the firmware server is to be accessed at the time during the time slot registered in the memory, and
wherein the controller is configured to:
cause, after causing the user interface to display the notification screen, the user interface to display a standby screen comprising a plurality of icons including a copy icon and a scan icon;
execute copying in response to the copy icon being operated, and execute scanning in response to the scan icon being operated;
cause, after causing the user interface to display the notification screen, the user interface to display the standby screen in response to receiving an operation on any one of the selection option corresponding to the cancellation and the selection option corresponding to the approval of the notification that are included in the notification screen; and
access, after causing the user interface to display the notification screen, the firmware server at the time during the time slot registered in the memory without causing the user interface to display the standby screen in a case in which no operation on any one of the selection option corresponding to the cancellation and the selection option corresponding to the approval of the notification that are included in the notification screen is received.

19. The printing apparatus according to claim 15,
wherein the controller is configured to:
access the firmware server at a timing different from the access time to the firmware server, and confirm whether there is firmware to be updated; and
not perform the notification that the firmware server is accessed at the time during the time slot registered in the memory even arrival of the time before the access time to the firmware server by the predetermined time in a case in which there is no firmware to be updated.

20. The printing apparatus according to claim 19,
wherein the timing different from the access time to the firmware server is within a predetermined time after the printing apparatus is turned on.

21. The printing apparatus according to claim 16,
wherein in a case in which the printing apparatus is turn on after a time before the access time to the firmware server by a third predetermined time which is shorter than the first predetermined time and longer than the second predetermined time, the controller is configured not to access the firmware server, and then output a notification via the user interface in response to arrival of a time before a next access time by the first predetermined time, the notification indicating that the firmware server is to be accessed at the time during the time slot registered in the memory.

22. A printing apparatus comprising:
a memory;
a network interface;
a user interface; and
a controller,
wherein the controller is configured to:
operate the printing apparatus by executing firmware stored in the memory;
access a firmware server on an Internet via the network interface, download firmware for update from the firmware server, and update the firmware stored in the memory with the downloaded firmware for update;
receive an input for designating a time slot via the user interface;
receive an input for enabling a first method via the user interface; and
receive an input for enabling a second method via the user interface,
wherein the second method is not allowed to be enabled in a case in which the first method is enabled, and the first method is not allowed to be enabled in a case in which the second method is enabled,
wherein in a case in which the first method is enabled, the controller is configured to access the firmware server at a time during the designated time slot every time a date for accessing the firmware server arrives, and
wherein in a case in which the second method is enabled, the controller is configured to access the firmware server every time the printing apparatus is activated.

23. The printing apparatus according to claim 22,
wherein in a case in which the first method is enabled, the controller is configured to update the firmware stored in the memory with the firmware downloaded from the accessed firmware server without requesting an input of an instruction to update the firmware via the user interface before the firmware stored in the memory is updated, and after the update, cause the user interface to indicate that the firmware is updated, after the update, and
wherein in a case in which the second method is enabled, the controller is configured to request an input of an instruction to update the firmware via the user interface before the firmware stored in the memory is updated, update the firmware stored in the memory with the firmware downloaded from the accessed firmware server in a case in which there is the requested input, and after the update, not cause the user interface to indicate that the firmware is updated.

24. The printing apparatus according to claim 23,
wherein the controller is configured to receive, as the input for designating the time slot, an input for designating a night time slot, an input for designating a day time slot, an input for designating an early morning time slot, and an input for designating an evening time slot,
wherein the controller is configured to receive an input for designating a day of a week via the user interface, and the date for accessing the firmware server is a date corresponding to the designated day of the week, and
wherein the controller is configured to:
receive an input related to a date for accessing the firmware server via the user interface; and
access the firmware server at a time during the designated time slot every time the date for accessing the firmware server based on the received input arrives.

25. The printing apparatus according to claim 23,
wherein the controller is configured to:
cause the user interface to display a standby screen comprising a plurality of icons including a copy icon and a scan icon; and
execute copying in response to the copy icon being operated, and execute scanning in response to the scan icon being operated,
wherein in a case in which the first method is enabled, after the firmware is updated, the controller is configured to cause the user interface to receive an operation on the plurality of icons and to display the standby screen indicating that the firmware is updated, and
wherein in a case in which the second method is enabled, before the firmware is updated, the controller is configured to cause the user interface to receive an operation on the plurality of icons and to display the standby screen for requesting an input of an instruction to update the firmware.

26. The printing apparatus according to claim 23,
wherein in a case in which the first method is enabled, the controller is configured to cause the user interface to display a warning that the firmware is automatically updated, and
wherein in a case in which the second method is enabled, the controller is configured not to cause the user interface to display the warning that the firmware is automatically updated.

27. The printing apparatus according to claim 23,
wherein at a time of initial installation of the printing apparatus, the controller is configured to cause the user interface to display a screen allowing an input for enabling the first method to be received and not allowing an input for enabling the second method to be received before causing the user interface to display a standby screen of the printing apparatus.

28. The printing apparatus according to claim 27,
wherein after the initial installation of the printing apparatus, the controller is configured to:
cause the user interface to display a standby screen comprising a plurality of icons including a copy icon and a scan icon;
execute copying in response to the copy icon being operated, and execute scanning in response to the scan icon being operated; and
cause the user interface to display a setting screen for receiving an input for enabling the second method by receiving an operation via the user interface after the standby screen is displayed.

29. The printing apparatus according to claim 22,
wherein in a case in which the first method is enabled, the controller is configured to access the firmware server at a time during the designated time slot every time the date for accessing the firmware server arrives,
wherein in a case in which the second method is enabled, the controller is configured to access the firmware server every time the printing apparatus is activated, and
wherein regardless of whether the first method is enabled or the second method is enabled, the controller is configured to cause the user interface to display the input screen for receiving the input of an instruction to access the firmware server in response to receiving the first input via the user interface, and access the firmware server in response to receiving the second input via the input screen.
